(19) United States
(12) Patent Application Publication
(10) Pub. No.: US 2015/0261914 A1
(43) Pub. Date: Sep. 17, 2015

(54) APPARATUS AND METHODS FOR ANALYSING BIOCHEMICAL DATA

(71) Applicant: Genestack Limited, Cambridge (GB)

(72) Inventors: Misha KAPUSHESKY, Cambridge (GB); Nikolay PULTSIN, Cambridge (GB)

(21) Appl. No.: 14/209,916

(22) Filed: Mar. 13, 2014

(51) Int. Cl. G06F 19/22; G06F 3/0482; G06F 3/0484; G06F 17/30

(52) U.S. Cl. CPC G06F 19/22; G06F 17/30076; G06F 17/30958; G06F 17/30179; G06F 3/0482; G06F 3/04842

(57) ABSTRACT

There are disclosed computer apparatus and computer implemented methods for analysing biochemical data such as biochemical sequence data. The apparatus and methods provide a suitable object-orientated environment for this analysis, including facilities for constructing a plurality of object-oriented biochemical data objects, each such object being arranged to encapsulate a biochemical data file within which biochemical data is recorded.

### INTRODUCTION

The present invention relates to computer apparatus and computer implemented methods for processing and/or analysing biochemical data, for example to carry out bioinformatics analysis and visualization of data such as biochemical sequence data. In particular, the invention provides a computer implemented object-oriented environment for such analysis.

The increasingly widespread use of genetic sequencing machines has lead to a proliferation in the amount of genetic data available for study, analysis and visualisation. However, such data typically exists as very large data sets, and computational tools for operating on such data sets can therefore require large amounts of computer resources in terms of data storage, working memory and processor time. A particular analysis to yield a useful bioinformatics result may often require many steps of calculation with various intermediate data sets being generated in the process.

Generally, a researcher will want to carry out a particular bioinformatics analysis multiple times with variations in the input data sets, parameters and calculation tools used, and may want to repeat a previous analysis perhaps with variations after a considerable intervening time of weeks or months.

The invention provides apparatus and methods for assisting the bioinformatics researcher in managing and keeping track of bioinformatics analyses of this type, while helping to control the computational and storage resources required, and allowing new bioinformatics techniques to be readily accessible to the bioinformatics researcher.

The invention is also applicable to other fields where similar issues of large data sets and multiple strands of replicated and modified analysis apply.

### SUMMARY OF THE INVENTION

Biochemical data such as genomic sequence data is conventionally stored in computer data files in a variety of data formats. For example, nucleotide sequences containing short segments (“reads”) scanned by a sequencer typically range from several tens to several thousand nucleotides in length, and are stored using data formats such as FASTQ, SFF, SRA, CRAM, SAM and BAM (this is far from being an exhaustive list). For each character in a read the data format also usually provides for storage of a computed quality value. The read characters and the quality values can be stored in numeric or textual form, depending for example on the sequencer technology. Quality values are typically integers (computed as round[−10 log₁₀ p] where p is an error probability) and are usually stored as ASCII characters, mapping to ASCII by adding 33 to the quality integer. Occasionally, however, 64 is added instead of 33. This value is called the offset value.

For genomic sequence data, and for various other biochemical data types, there is no single standard data format—all formats are agreed upon de facto. Moreover, there are typically no defined headers or metadata in these data formats to inform the user of how the biochemical data is stored. One of the first steps of genomic sequence analysis is often pre-processing for control of quality data. Some tools for doing this use FASTQ files as input, and some use BAM files as input, and not knowing the correct offset for the quality values can lead to gross misinterpretation of the data.

Similar problems occur in other areas of bioinformatics, including representation of reference genomes, expression data from microarray technology, protein structures, nuclear magnetic resonance spectra and so forth.

The invention therefore provides computer apparatus for analysing biochemical data, in which biochemical data objects are constructed each of which may encapsulate a biochemical data file in which biochemical data is recorded. In this way, the invention can provide polymorphic representations of biochemical data as interfaces, and hide all non-biochemical details such as knowledge about specific formats and implementations. The apparatus can thereby provide an object-oriented environment for example to carry out bioinformatics data analysis.

The biochemical data objects can be used to separate the biological domain entity denoting the data from the physical implementation in a specific format. For example, the biochemical data of each biochemical data object may be recorded in the biochemical data file according to any of a plurality of different formats suitable for that biochemical data, and each such biochemical data object then provides an interface to one or more object-oriented methods for reading part or all of the biochemical data from the biochemical data file. The interface is arranged to return the read biochemical data in a standard form or structure which does not depend on which of the predefined formats the biochemical data is recorded in the biochemical data file.

Indeed, the object-oriented interface may be the same for all of the biochemical data objects, and/or between different formats for a particular type or compatible types of biochemical data.

The biochemical data may be biochemical sequence data, such as nucleotide data including for example DNA, RNA cDNA and other sequences such as protein and other types, with some suitable predefined formats being FASTQ, SFF, SRA, CRAM, SAM, BAM. The biochemical data may be other types of biochemical data such as sequences of nucleotide chemical-physical properties, wiggle data, or genomic variant data with some predefined formats being WIG, BED, VCF and others.

Note that, although a particular biochemical data object could encapsulate only one biochemical data file, the apparatus could also be arranged such that one or more of the objects encapsulate multiple biochemical data files, and these could be of the same or different biochemical data types, and/or of the same or different predefined formats even if of the same biochemical data type.

In bioinformatics, data files often come in different, poorly annotated formats without headers to explain what is stored in a file. In some files, headers are available, and when data is retrieved from bioinformatics database, metadata comes in the form of various records with fields. An important problem is here is inconsistency and poor control over the types of data. For example, it is possible to retrieve a dataset, in which a numeric field such as “age” will have the value “adolescent”, or the field “ethnic group” might have the value “C57BL/6” (a common mouse strain). The value “adolescent” is not only non-numeric, but also might not have a standard interpretation, whereas a mouse strain could end up in the ethnic group field if two databases (human and mouse) were at some point merged.

The invention may therefore also provide a robust and well-controlled system of metadata, provided by a rich meta-information type hierarchy for biochemical data objects that allows to specify extensive metainfo fields for these objects. One kind of metadata value used in the objects is “FileReference”. This permits biochemical data objects to have links to other such objects in their metadata. For example, a biochemical data file encapsulating mutations in an organism can have a link to the genome from which these mutations show differences.

The metadata aspect of the computing environment permits specifying and controlling extensive metadata attributes for all represented biochemical data entities. Because the environment is object-oriented and all types are checked as a built-in feature of the entire system, it is impossible to put a non-numeric value into a numeric attribute. Some metadata fields are specified as Enumerations. This means that the value of such a field must come from a predefined list, for example, sequencing technologies, or organisms. This ensures consistency and robustness of the metadata.

In particular, each biochemical data object may comprise, which includes being associated with, a plurality of metadata fields. Preferably, at least some of the plurality of metadata fields specify provenance of the biochemical data, for example identifying one or more of the following to which the biochemical data relates: an organism species; a strain of an organism species; an age of an organism; a tissue type; cell type; cell line; developmental stage; chemical treatment by compound with dosage duration and so forth. Such fields may typically be inherited along a sequence of bioinformatics calculations based on biochemical data originally derived from an organism having the stated property. Similarly the provenance metadata may identify one or more sets of data used in calculation of the biochemical data, such as a reference genome; the biochemical data of another biochemical data object, a particular assay, group of assays, an experiment, group of experiments, auxiliary files e.g. containing supporting data indexes, other reference data tables, and so forth.

Provenance metadata may also comprise creation parameters used or to be used for the creation of the biochemical data. More specifically these could comprise the command line parameters used in the creation of the biochemical data file. Provenance metadata could also comprise any of, details of the researcher or research group that was responsible for the creation of the biochemical data, when the creation occurred, which person, group or organization owns the biochemical data, and so forth.

Optionally, provenance metadata may also identify or comprise other biochemical data on which the biochemical data depends or is derived from.

The bioinformatics functionality of the object-oriented computing environment provided by the apparatus may be provided, at least in part, by using application objects to act on the biochemical data objects described above. The application objects may carry out various operations such as creating a biochemical data object, causing biochemical data to be encapsulated by a biochemical data object, providing visualisation and other display functionality of a biochemical data object and/or its encapsulated biochemical data, and carrying out bioinformatics calculation and processing operations on the biochemical data of one or more objects to produce an output to be encapsulated by another object.

To this end, there may be provided within the computing environment a plurality of application objects, each application object encapsulating or specifying an operation which is adapted to do at least one of: accept biochemical data from a biochemical data object for processing by the operation; and deliver biochemical data processed by the operation to a biochemical data object. A typical bioinformatics processing operation, for example a sequence alignment operation will typically accept biochemical data from one or more biochemical data objects, and deliver result data to one or more different biochemical data objects. At least some of the application objects are arranged to create a new biochemical data object, for example to provide a structure within which to encapsulate newly sourced or calculated biochemical data.

An operation relating to data visualisation could be, for example, a genome browser or other graphical tool for viewing genome or other biochemical data. An operation for carrying out a bioinformatics operation could be for example, a sequence alignment operation using an alignment tool such as BLAST; computation of differential expression statistics (or any statistics in general); identification of genomic variants; annotation of genomic variants against a known set of variants. An operation for obtaining data for encapsulation within a biochemical data object could, for example, arrange download of data from a remote site using a URL.

Typically application objects define operations and their implementations and specific operations may include, the ability to use biochemical data objects as templates to create new objects; the ability to process biochemical data files uploaded onto the system such that these biochemical data files are encapsulated by new biochemical data objects; the ability to provide downloadable biochemical data files from existing biochemical data objects; the ability to visualize biochemical data objects; and the ability to import biochemical data from outside the system, preferably into new biochemical data objects.

Application objects may also be arranged to provide methods callable by other application objects. In particular application objects may be remoteCall and library application objects, i.e. they provide methods that other application objects can call directly, from externally, for the former, and from initialisation Python scripts, for the latter.

Many biochemical data sets such as genomic data sets are relatively cheap to produce and very large in size. For example, one human genome can occupy around 500 gigabytes of disk space. When processing biochemical data sets, a computer system may often need to commit many times more free memory than the size of the raw data, to accommodate intermediate results and working space of the bioinformatics tools. After all of the processing has been carried out, often only a relatively small set of output data needs to be retained—computations are expensive and take a lot of time.

To address these and other issues, biochemical data objects may be initialised in an “empty” state. This means that when a biochemical data object is created, the physical data that it represents might not yet have been computed or be present in the system. In other words, only a “shell” of the object exists, initialised with suitable metadata values and functionality for subsequent initialisation into an “initialised” state, for example by calling an “initialise( )” method of the empty biochemical data object. Each biochemical data object can have a different, custom-defined initialisation method, normally specified at the time of creating the biochemical data object by an application object. This separation of biochemical data object creation and initialisation allows the computing environment to be highly cost efficient—no compute time is used and no storage is required until the biochemical data file is actually needed for another step in a data flow process.

The availability and use of “empty” and “initialised” states also allows biochemical data files to be returned to the empty state by a de-initialisation process whereby the biochemical data is discarded, if this is required, for example so as to save on data storage requirements. Because the de-initialised biochemical data object still contains all the same original metadata and other information required, the biochemical data can then be recomputed again at a later date through another initialisation step. This facility then enables an operator of the computing environment to achieve a balance between storage costs and compute costs.

To this end, at least one of the application objects may be arranged to create a new biochemical data object in an empty state in which the biochemical data file is not yet complete, the new biochemical data object being adapted to subsequently transition, using the operation specified by the application object, from the empty state to an initialised state in which the biochemical data file is complete.

The change from a not yet complete data file to a complete data file may typically comprise calculating wholly or in part the biochemical data for inclusion in the data file using a bioinformatics tool or algorithm, but may also or alternatively include obtaining the data from a remote or local source, writing the data into the data file, and/or encapsulating the data file into the biochemical data object. The transition could be carried out by calling a suitable initialise method of the object-oriented interface of the biochemical data object. A metadata flag may be provided in the biochemical data object to indicate whether the biochemical data object is in the empty state or the initialised state. Alternatively the presence of metadata and flags associated with those metadata may enable a method of the biochemical data object to deduce the initialisation state of the biochemical object.

The transition from the empty state to the initialised state may be triggered, for example, by a user interaction with the computing environment which takes place after creation of the new biochemical data object in the empty state. This user interaction could be a direct instruction to transition an object to the initialised state, could be a user instruction to execute a data flow (for example as discussed below) which requires this transition to take place to complete the work flow, and/or could be triggered by a method of the biochemical data object attempting or requesting to read data from the biochemical data file which is not yet encapsulated or complete in the sense required. The apparatus also may be arranged such that a user can create a plurality of biochemical data objects in the empty state before any of the plurality are transitioned to an initialised state.

Some or all of the biochemical data objects may be adapted to subsequently revert from the initialised state back to the empty state. This may include discarding or deleting the biochemical data in the encapsulated biochemical data file, for example to save storage space, especially when the data file is large. However, the apparatus may be arranged such that the reverted biochemical data object is enabled to subsequently transition back to the initialised state.

It may be desirable for biochemical data objects, once initialised, to be immutable, in the sense that alter a transition from the empty state to the initialised state, the biochemical data file will always be the same in the initialised state, even following one or more reversions back to the empty state, and this immutable property of some or all of the biochemical objects may be enforced by design of the apparatus. Typically, the reversion process to the empty state may only be available to an operator of the apparatus, and not to end users. This immutability will be effective for operations which are deterministic, and this property ensures robustness of the apparatus. To this end, the apparatus may be arranged such that some but not all of the operators found in application objects are permitted to be the subject of a biochemical data object transition back to an empty state. Examples of operations where this may not be appropriate are operations which import biochemical data from a remote source using a URL, and bioinformatics operations which are not deterministic to a sufficiently high level of accuracy.

The working processes of bioinformatics scientific investigations tend to follow multiple paths. A researcher might start with one raw data file, for example a genome file, and follow different analytic strategies or try the same strategy with multiple different parameters. Working with physical data files directly using scripts and tools under a conventional operating system, it is easy for a researcher to become lost and confused and be unable to reproduce previous her work after some weeks or months. In a different scenario, a clinical geneticist might conduct an analysis of a patient's genome with tools available on a certain date, and some months later, might be called on to conduct a repeat analysis to compare results. It would be desirable that in both examples the geneticist be able to reproduce prior analyses exactly, either on the same data or on a different set of starting data files.

The invention therefore provides the concept of data flows to address this problem. By tracking carefully the provenance of biochemical data objects using metadata fields, the entire graph of all dependencies of any biochemical data object can be derived, sufficient for a complete re-computation of all steps that led up to the creation of a particular biochemical data object in its initialised state. Moreover, this provenance graph can be saved as a self-standing object in the computing environment, and can be re-used to create additional biochemical data objects and data flows of multiple such dependent objects. In other words, a data flow can be replayed on different inputs.

A data flow can be re-used to create new biochemical data objects. Importantly, one can re-use either a whole data flow or just a part of it. A part can be re-used by taking an existing data flow and replaying it, but starting from somewhere in the middle. Similarly, a data flow can be re-used from a single biochemical data object to replicate analysis for multiple such objects.

Any data flow that uses one biochemical data object as its input at some point can be replicated for multiple objects. To the end user the operation is as simple as selecting multiple biochemical data objects through an object chooser component of a user interface. Multiple data flows will then be initiated and multiple intermediary and end-result biochemical data objects will be created. Note also that no compute or storage space will be used until the user requests initialization of these new objects. As with data flow replay, initialization also does not need to take place for the entire data flow, but only up to the point needed by the user.

Accordingly, the apparatus may be arranged such that the transition from the empty to the initialised state of a first biochemical data object requires the biochemical data from a second of the biochemical data objects, and is therefore dependent upon the second biochemical data object being in the initialised state, thereby forming a data flow dependency between the first and second biochemical data objects, a graph of such data flow dependencies between a plurality of biochemical data objects forming a data flow in which each biochemical data object has a data flow role. In particular, to calculate the biochemical data of the first object requires the biochemical data of the second object, and so forth within a graph of such dependencies.

The computing environment may provide a data flow capture function arranged to follow a chain of data flow dependencies to determine the graph. However, the graph will also typically be implicit from the metadata and/or related information associated with the biochemical data objects.

Due to the nature of the dependency graph, a request, for example, based on a user instruction to transition from the empty to the initialised state of a selected biochemical data object may automatically cause transition to the initialised state of at least some of the biochemical data objects in the empty state upon which the selected biochemical data object directly or indirectly depends according to the graph. This could be overtly controlled by a scheduling function, and/or may be implicit in the methods used to initialise each biochemical data object automatically causing methods to be called which initialise objects upon which they depend. However, the computing environment may also provide functionality to automatically determine if a graph is invalid, in the sense that not all of those ones of a plurality of biochemical data objects forming a graph according to their dependencies which are in the empty state can be transitioned to the initialised state. Such an invalid state could be due to a circular dependency for example, or some other defect, for example, insufficient permissions to access one of the dependencies.

The initialisation state of a biochemical object can further be determined by the initialisation state of other biochemical objects in the dependency graph, which can be deduced by an object-orientated method of the biochemical object.

Because the graph can be determined, a resource function may be provided to schedule transition, of those of a plurality of biochemical data objects forming a graph which are in the empty state, to the initialised state. This scheduling could be carried out for example according to available memory resources for completing the encapsulated biochemical data files during the initialisation processes, available processor time for completing the encapsulated biochemical data files, and other issues.

The computing environment provides a user interface enabling a user to reproduce at least a part of an existing data flow for subsequent use in a modified form. This enables a bioinformatics data flow to be reproduced with modifications for example in the parameters, bioinformatics operations, and input data used for each operation. Effectively, the user is enabled to branch an existing data flow at a chosen point, typically replicating the data flow dependencies beyond that point (although not necessarily replicating the biochemical data objects or all of the details of those objects) and making changes to the properties of the replicated data flow to carry out a variation on the previous bioinformatics data flow experiment.

In particular, the user interface may be arranged to enable the user to replicate the data flow roles of one or more biochemical data objects forming part of an existing data flow to form corresponding new biochemical data objects in the replicated roles, to thereby re-use at least a part of the data flow in a modified form. The user interface may enable the user to choose a copy of an existing biochemical data object to use in the replicated data flow role of the selected biochemical data object, and/or to choose a copy of the selected biochemical data object to use in the replicated data flow role of the selected biochemical data object. Generally, the user interface will enable the user to edit properties of the chosen biochemical object for use in the replicated data flow role.

It can be appreciated that the generation and use of such dataflows is not limited to methods and apparatus in which the described empty and initialised biochemical data objects are used, or in which there is a delay or required user interaction between creating the empty state and transitioning to the initialised state. The dataflow aspects described can also be applied, for example, in systems where biochemical data objects are initialised upon creation. In this sense it can be envisioned that new biochemical data objects would be created at the end of the dataflow replication process as opposed to being modified during the replication process. For example the invention may also provide for a first biochemical data object including its completed biochemical data file requiring the biochemical data from a second of the biochemical data objects, therefore being dependent upon the second biochemical data object including the completed biochemical data file of that second object, thereby forming a data flow dependency between the first and second biochemical data objects, a graph of such data flow dependencies between a plurality of biochemical data objects forming a data flow in which each biochemical data object has a data flow role. When running similar bioinformatics analyses on multiple inputs from a command line shell or similar computing environment, it is usual to end up with numerous file system directories, often with similar names, with multiple directories also containing bioinformatics data files with similar or identical names, for example:

```
trial1
  |---- p33_tophat_1_t1.bam
  |---- p33_tophat_2_t1.bam
  |---- p33_tophat_3_t1.bam
      . . .
trial2
  |---- p33_tophat_1_t2.bam
  |---- p33_tophat_2_t2.bam
  |---- p33_tophat_3_t2.bam
      . . .
```

Sometimes the _t1 or _t2 suffixes might be omitted form the file names so that trial1 and trial2 directories would contain files with identical names, because for example they are the outputs from two trial bioinformatics computations on the same input files. This occurs frequently when running an external script on multiple collections of input files. In order to create files with meaningful names, the bioinformatician must either modify existing third party scripts, develop their own wrappers, do the renaming post factum, or cope with the existing file name difficulties.

To address this issue, the computing environment uses the metadata already mentioned above. For example, since the name of a biochemical data object itself is represented as a metadata field of that object, it can be automatically of semi-automatically updatable by allowing metadata fields to include references to other metadata fields. This way, the name field of a biochemical data object can be defined as a string that includes metadata fields from other biochemical data objects and/or application objects, for example biochemical data objects used as inputs, or application objects used to process those inputs. Therefore, when a dataflow is replicated or re-used as discussed above, or a biochemical data object is used as a template to create one or more new biochemical data objects, the name field of any newly created biochemical data object or objects is immediately and automatically updated with attributes from new inputs.

Accordingly, the metadata fields of a second biochemical data object may comprise at least one descendent metadata field which comprises metadata from at least one parent metadata field from a first biochemical data object upon which the second biochemical object is directly or indirectly dependent for calculation of its biochemical data. Similarly, a descendent metadata field may comprise metadata from at least one parent metadata field from, or whose value is set by, an application object upon which the biochemical data object is directly or indirectly dependent for calculation of its biochemical data.

The parent metadata field of a biochemical data object might typically specify the name of an organism species, strain, age or tissue type application from which the biochemical data is derived, or similarly identify a particular assay, experiment or group of assays or experiments, or a reference genome against which a calculation has been made in deriving the data. Similarly, the parent metadata field from, or whose value is set by, an application object might typically specify a name or version number of an operator, such as a bioinformatics tool, parameters for that operator in calculating the biochemical data, a date and/or time at which the biochemical data object was created by applying the application object to the input biochemical object, and so forth.

Conveniently, the descendent metadata field may comprise a reference to the parent metadata field, so that the metadata is comprised in the descendent metadata field by means of the reference. This can provide a basis for the descendent metadata field to be comprised in the descendent metadata field by means of recursive references through one or more parent metadata fields each of which is in turn a descendent metadata field of another parent metadata field, and can also cause a descendent metadata field to be automatically updated if a directly or recursively related parent metadata field is modified.

By way of example, the descendent metadata field may be a string or text field descriptive of the biochemical data object to a user, for example being used as a name or title of the object in a graphical user interface.

The invention also provides graphical user interface facilities for putting into effect the various aspects described herein. For example, the computing environment provides a graphical user interface, such as an object browser, enabling a user to select one or more of a plurality of biochemical data objects which are graphically represented to the user, and to apply an application object which is graphically represented to the user to the selected biochemical data object(s).

The graphical user interface may restrict the application objects which can be applied to particular selected biochemical data objects, for example by calling a method of each application object with the selected biochemical data objects as inputs, the method returning an indication of whether the selected biochemical objects can be used with that application object. This indication can be reflected in the interface by not showing or displaying in a different style those application objects which cannot be so used.

The graphical user interface may also provide one or more suitable controls for launching an initialisation from an empty status to an initialised status, and may also provide a display of data flow dependencies between biochemical data objects which can be used to replicate existing data flows with modifications to enable new bioinformatics calculation sequences to be carried out based on existing data flow sequences.

The invention also provides methods corresponding to the above apparatus and computer environment aspects. For example, the invention also provides a method of operating an object-oriented environment comprising: constructing a plurality of biochemical data objects, each biochemical data object being arranged to encapsulate a biochemical data file within which biochemical data is recorded. For example, some or all of the biochemical data may be biochemical sequence data. Each biochemical data object may be constructed such that it comprises a plurality of metadata fields, one or more of the plurality of metadata fields being arranged to specify provenance of the biochemical data to be recorded in the biochemical data file.

The methods of the invention may also comprise providing a plurality of application objects each encapsulating an operation for use with the biochemical data objects, such as a bioinformatics calculation, a data download operation, a visualisation operation, and so forth. Especially for bioinformatics operations, the application objects may then be applied to or run on at least a first one of said biochemical data objects encapsulating a first biochemical data file, to create a second one of said biochemical data objects in an empty state in which it is arranged to encapsulate a second biochemical data file. The methods may then include subsequently initialising the second biochemical data object from the empty state to an initialised state, comprising the operation acting on the at least a first one of said biochemical data files to create the second biochemical data file, and the second biochemical data file being encapsulated by the second biochemical data object.

The methods of the invention may also involve handling data flows, for example wherein the transition from the empty state to the initialised state of the second biochemical data object requires the biochemical data from the at least a first one of the biochemical data objects, and is therefore dependent upon the at least a first one of the biochemical data objects being in the initialised state, thereby forming a data flow dependency between the second and the at least a first one of the biochemical data objects, a graph of such data flow dependencies between a plurality of biochemical data objects forming a data flow in which each biochemical data object has a data flow role.

The methods may then comprise reproducing at least a part of an existing said data flow by creating one or more new biochemical data objects having the same data flow roles in the new data flow as one or more corresponding biochemical data objects in the existing data flow.

The methods of the invention may also comprise constructing one or more of the biochemical data objects such that they each comprise a plurality of metadata fields, one or more of the plurality of metadata fields being arranged to specify provenance of the biochemical data recorded or to be recorded in the biochemical data file, wherein the plurality of metadata fields of a particular biochemical data object comprise at least one descendent metadata field which comprises metadata from at least one parent metadata field, which is from a first biochemical data object upon which the second biochemical object is directly or indirectly dependent for calculation of its biochemical data, or which is from an application object upon which the biochemical data object is directly or indirectly dependent for calculation of its biochemical data.

The apparatus and methods of the invention may be implemented on a variety of suitable computer apparatus, for example comprising one or more computer processors, working memory such as RAM associated with the processors, non-volatile storage such as disk drives, and graphical user interface peripherals such as display screens, keyboards and pointing devices. Such computer apparatus may be distributed in various ways, for example being collocated in one or more workstations, servers and other arrangements suitable connected by data network connections.

The invention may also be provided as computer program code arranged to put aspects of the invention into effect when executed on suitable computer apparatus. Such computer program code may be stored on one or more computer readable media, transmitted as a signal over a network, and provided in other ways familiar to the skilled person.

Although aspects of the invention are described herein largely with reference to carrying out bioinformatics work on biochemical data, the arrangements and techniques described can also be applied to other types of data, in which case terms such as “biochemical data”. “biochemical data object”, “biochemical data file” and “bioinformatics data flow” may be more generally understood as “data”, “data object”, “data file” and “data flow”, or made explicit to more particular aspects of bioinformatics work such as bioinformatics sequence data, or made explicit to other fields such as financial data, astro- or high-energy physics, social media data, governmental data, network traffic, and so forth. In this respect, particular types and fields of metadata associated in this document with a biochemical data object may then be translated to types and fields of metadata associated with data in said other fields, such as bank account attributes, social network user details, networked device properties, and so forth.

### BRIEF DESCRIPTION OF THE DRAWINGS

Embodiments of the invention will now be described, by way of example only, with reference to the accompanying drawings of which:

FIG. 1 shows a system comprising an object-oriented computing environment for carrying out bioinformatics work;

FIG. 2 illustrates biochemical data objects for use within the environment of FIG. 1;

FIG. 3 illustrates application objects for use within the environment of FIG. 1;

FIG. 4 illustrates operational relationships between an application object run on a first biochemical data object to create a second biochemical data object which is subsequently initialised;

FIG. 5 shows a data flow between multiple biochemical data objects and functions of the computing environment relating to this data flow;

FIG. 6 shows a working example of such a data flow for carrying out a bioinformatics task;

FIG. 7 illustrates a data flow which is invalid due to a cyclic dependency;

FIG. 8 shows some ways in which data flows may be re-used, replicated or re-played to carry out further bioinformatics work:

FIG. 9 illustrates the use of references between metadata fields to help manage naming and other user issues when replicating of objects and data flows;

FIG. 10 illustrates an object browser for a user to manage objects in the computing environment;

FIG. 11 shows a chooser menu for application objects implemented in the object browser of FIG. 10;

FIGS. 12 and 13 show operation of an application pane for selecting an application object in the object browser of FIG. 10;

FIG. 14 illustrates a biochemical data object display window of the object browser;

FIGS. 15 and 16 illustrate replication of a biochemical data object using the object browser;

FIGS. 17 and 18 demonstrate execution of a data flow and presentation of such a data flow using an object provenance display window of the object browser;

FIG. 19 shows an interface of a data flow replay tool of the object browser, which can be used to replicate and replay existing data flows to carry out further bioinformatics work by copying aspects of an existing data flow and making suitable changes; and

FIG. 20 shows an exemplary system architecture for implementing the described object-oriented computing environment for bioinformatics or other work.

### DETAILED DESCRIPTION OF EMBODIMENTS

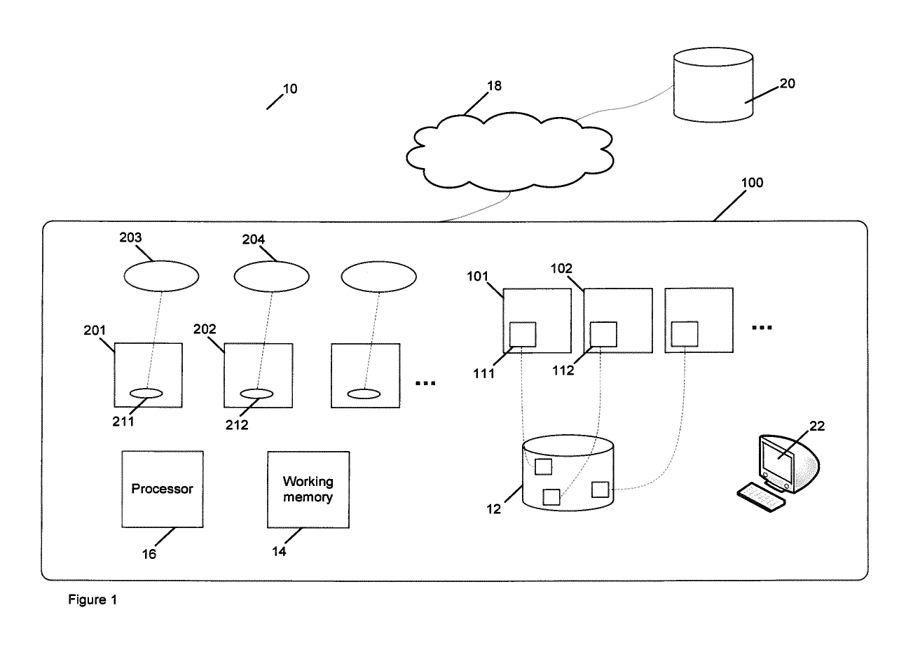

Referring now to FIG. 1 there is illustrated a system 10 for carrying out bioinformatics work. The system implements an object-oriented computer environment 100 in which biochemical data resulting from and for use in bioinformatics calculations is stored in biochemical data files 111,112 which are encapsulated, in the object-oriented sense, within biochemical data objects 101, 102. In practise, the biochemical data files 111, 112 may be stored in various ways such as in non-volatile memory such as disk storage 12 available to the environment 100, and loaded into working memory 14 such as RAM of a computer processor 14 as and when needed. The biochemical data objects 101,102, and/or data defining these objects may be similarly stored in disk storage 12 and/or working memory 14 as required. Discussions of some other ways in which the environment maybe implemented is provided towards the end of this document, for example using multiple processors and different storage configurations.

The environment also provides application objects 201, 202 which encapsulate operations 211, 212 which can be performed on a biochemical data object 101, 102, for example to carry out a bioinformatics calculation on the biochemical data in the encapsulated data file 111, 112, and to thereby complete a new biochemical data file containing the results of the calculations which is encapsulated in a new biochemical data object. Ways in which a new biochemical data object may be created by an application object, but the use of the operation to carry out the relevant bioinformatics calculations may be deferred until a later time, are discussed in more detail below.

The application objects and their encapsulated operations may also carry out a variety of other tasks within the environment 100, for example by creating a new biochemical data object to manage the intended calculations and encapsulate the output when an application object is run on an existing biochemical data object, to provide visualisation and graphical output of the biochemical data file encapsulated within an existing biochemical data object, and to provide visualisation and control of biochemical data objects and relationships between them.

Since a bioinformatics work frequently involves applying a sequence of analysis operations involving various biochemical data inputs, and in the present invention each analysis operation is implemented using a biochemical data object, these objects can therefore represent work flows or data flows representing such sequences. Some application objects may therefore be provided to manage relationships between the objects, and to replicate existing data flows for use with varying data inputs and parameters. The implementation of data flows in the environment is also discussed in more detail below.

The operations 211, 212 encapsulated by the application objects 201, 202 may be implemented in various ways, for example using scripts to run corresponding executable code 203, 204 of bioinformatics tools such as BLAST or other alignment tools.

Bioinformatics data for use within the environment may frequently be available for download over a network 18 such as the Internet, from remote servers 20. The environment may therefore be arranged, for example using one or more specific application objects for the purpose, to create new biochemical data objects and to download into data files 111, 112 within the environment such bioinformatics data, with these data files being encapsulated within biochemical data objects for further analysis and processing.

The environment is also provided with one or more graphical user interfaces 22 enabling users to carry out bioinformatics work using the environment. Such interfaces may be implemented in well known ways using graphical displays and input peripherals, and operating using software implemented on the processor 16 and memory 14.

Although the computing environment is described herein largely with reference to carrying out bioinformatics work on biochemical data, the arrangements and techniques described can also be applied to other types, in which case terms such as “biochemical data”, “biochemical data object” and “biochemical data file” may be more generally understood as “data”, “data object” and “data file”, or made explicit to particular aspects of bioinformatics work such as bioinformatics sequence data, or other fields such as financial data.

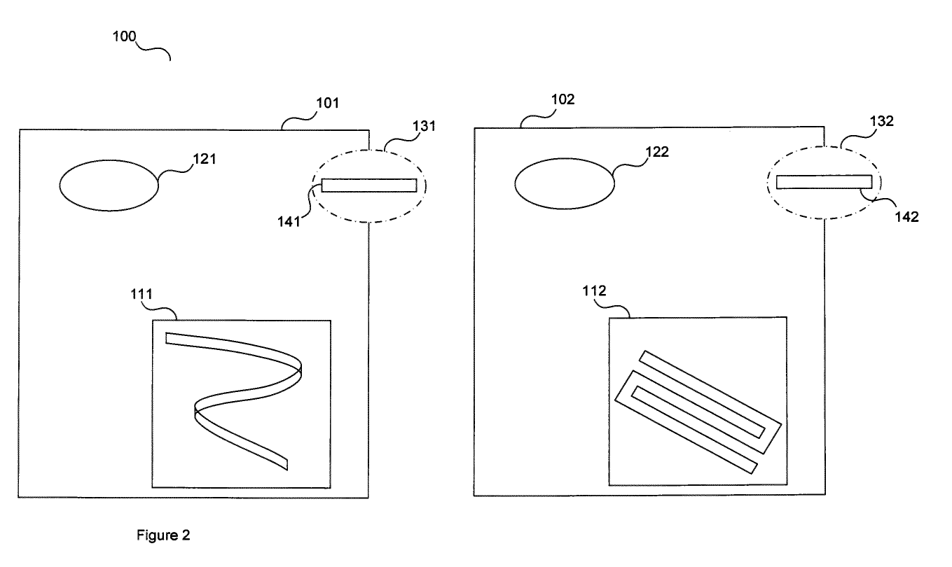

Referring now to FIG. 2 there are multiple biochemical data objects which can be constructed in the object-oriented computing environment 100. Two such objects 101, 102 are shown in the figure. Each biochemical data object encapsulates a biochemical data file 111,112 in which biochemical data is recorded, and also provides an object orientated interface 131,132 for the computing environment to run methods for interacting with the data files, for example to read data from the data files into a particular format for further use by another part of the computing environment.

The data files may contain a variety of types of biochemical data, for example RNA, DNA and protein sequences, raw genome data in the form of aligned or unaligned reads from a sequencing experiment, micro-array assay data, constructed genome data, gernome BED data or wiggle data, KED data, metabolic pathway data, genomic variant data, computed gene expression statistics and so forth. Many but not all such types of biochemical data directly represent biochemical sequences such as DNA or RNA sequences, or corresponding sequences of properties directly relating to the elements of such sequences. Some such data types may result from experiments, from information theory based approaches and so forth. Some particular such types of biochemical data may be written in the data files in number of different data formats. Some such types of data may also be written in the data files in the same format as some other such types, for example FASTQ or CSFASTA files for raw sequence data or SAM or BAM files for mapped short read data; SRA, SAM and RAM files may be used for both raw and mapped short read data. In other words, the data encapsulated by at least some biochemical data objects could be recorded in the data file according to any of a plurality of different predefined formats suitable for that biochemical data.

The computing environment 100 is arranged to construct the biochemical data objects such the relevant interface 131, 132 provides access to the data in the data file in an invariant manner regardless of the particular format in which the data is written. For example, each biochemical data object may provide an interface to one or more methods for reading the biochemical data from the biochemical data file, the interface being arranged to return the read biochemical data in a form which is invariant to which of the predefined formats the biochemical data is recorded in the biochemical data file.

If the two illustrated objects 101, 102 encapsulate biochemical data of compatible types or the same type, then the object-oriented interfaces 131,132, or parts of these interfaces may be the same for both biochemical data objects.

In the example of FIG. 2, each biochemical data file 111, 112 contains biochemical sequence data of some form, and is typically a file stored on a traditional computer file system (such as ext3 or FAT32), which resides on some storage medium. The biochemical sequence data in each the file is represented in a data format suitable for the sequence data, this format being generally determined by the nature of the biochemical sequence data and how the biochemical data has been generated. Examples of such formats could be, Stockholm format, Pileup format, BAM, FASTQ, etc. The biochemical data 111,112 in FIG. 1 are in different formats to each other, but are of compatible types so that at least aspects of the data in each file can be translated into a common format exposed by each of the interfaces 131, 132.

The object-orientated interfaces provide at least one method. 141 and 142, through which other elements in the environment, outside the biochemical data object, can interact with the data stored in the biochemical data file encapsulated in the biochemical data object. Because the objects 101, 102 in FIG. 2 encapsulate biochemical data of compatible types, the methods provided by the common interface appear the same outside each biochemical data object. For example, a particular read( ) method of one biochemical data object would take the same types of arguments, and produce the same type of output and format if output data as a read( ) method of the biochemical data object, regardless of which of multiple suitable data formats have been used to write the biochemical data in the data file.

Of course, the detailed implementation of the methods in a given biochemical data object will depend on the format of the biochemical data in the file encapsulated by the biochemical data object. The result of this is that the particular formats of the data in the biochemical data files are not necessarily exposed to the computing environment external to the biochemical data objects. Any format conversion required when a biochemical data object is used is handled automatically by the methods 141, 142 of the biochemical data object.

The methods can also allow a biochemical data object to return the results of various data processing actions that can be carried out upon the biochemical data file, including various types of read actions although other types of actions such as write actions and so forth could also be implemented. For instance a method could return a specific biochemical sequence from the data file, a specific set of quality values in a given format, a set of genomic variants, a numeric data matrix containing differential gene expression statistics in a predefined format, etc.

For example, consider a computing environment 100 in which there are two biochemical data objects A and B. Biochemical data object A encapsulates a biochemical data file P containing a sequence of mouse DNA in the FASTA format. Biochemical data object B encapsulates a biochemical data file Q containing a second sequence of mouse DNA in the BAM format. A user now wants to run a BLAST application on both sequences in order to compare each one to a human reference genome. The BLAST application only takes as input sequence data in the FASTA format.

Both biochemical data objects A and B as part of their common object-orientated interface have a getFASTA( ) method which, when called, returns the biochemical sequence data stored in the biochemical data object's biochemical data file in the FASTA format. In the case of biochemical data object A the computing environment calls the getFASTA( ) method, which just returns the contents of the biochemical sequence data file P. The computing environment can then provide this to the BLAST application as input. In the case of biochemical data object B, again the computing environment just calls the getFASTA( ) method. This time the method retrieves the BAM biochemical sequence data from the biochemical data file Q and the converts it to the FASTA format. The method then returns this converted data, now in the FASTA format. As before the computing environment can supply this data directly to the BLAST application. At no point in the process did the user or the computing environment outside of the biochemical data objects need to consider what format the biochemical sequence data is actually stored in the physical data files. From the perspective of the user, biochemical data objects A and B work in exactly the same way.

It will be appreciated, however that this get functionality does not have to be separated into specific methods for specific formats. Indeed it is also possible to have a general get( ) method which could take as an argument the required format. So instead of calling getFASTA( ) or getBAM( ) the general get( ) method could instead be called as get(“FASTA”) or get(“BAM”) respectively.

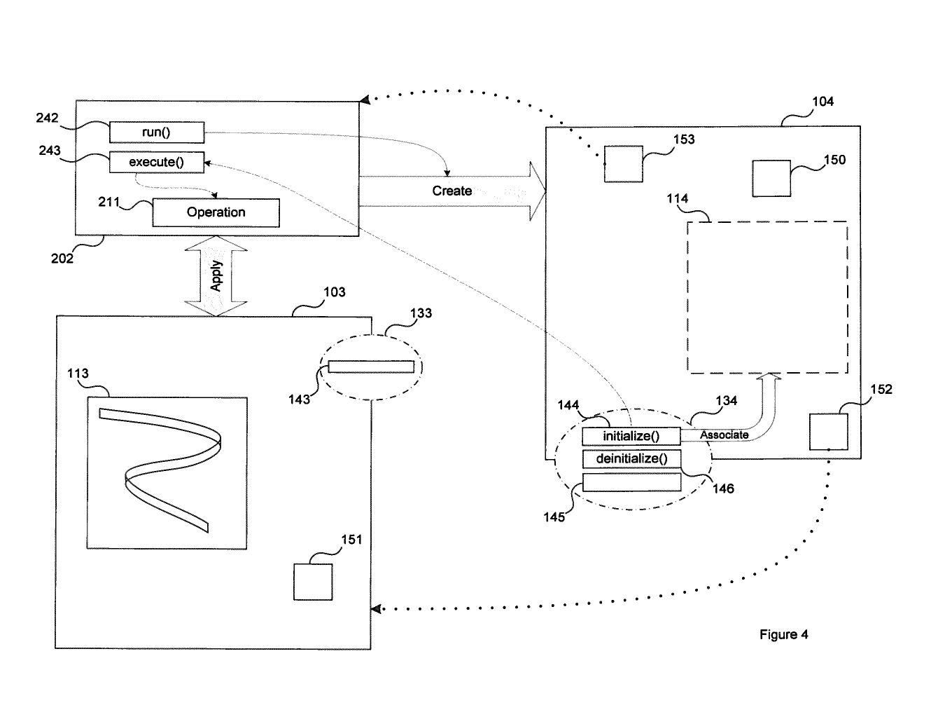

Each biochemical data object may also have a set of metadata 121, 122. This metadata is intended to be a complete record, as far as practical, of the attributes of the biochemical data in the biochemical data file. For example the type of data is recorded e.g. specifying an RNA sequence, a DNA sequence, or a protein sequence; the species and strain of organism from which the data comes; the age of the subject organism etc. The metadata is strongly typed, for example “age” could only take a numeric value, and allowable values for various parts of the metadata can be dependent on other parts of the metadata. An example of this is if the metadata defined the biochemical data as relating to a mouse, only valid mouse strain types would be allowed to be recorded in a metadata field specifying strain. The metadata may also include data relating to operation of the system and function inter-relationships between the biochemical data objects, for example initialised flags 150, 151, and dependency link 152 as illustrated in FIG. 4.

One important type of metadata item is a file reference. File reference metadata items enable a biochemical data object to include a link, using this metadata, to another biochemical data object. For example, a biochemical data object encapsulating mutations in an organism can have a link using this type of metadata to another biochemical data object encapsulating the genome from which these mutations show differences.

Additionally each item of metadata or metadata field can have one or more associated attributes. In addition to the usual specification of type (e.g., String Value or Memory Size Value, or a value from a known enumeration), there can be attributes specifying if a particular metadata field is:

“Required”—if true then the biochemical data object must have a value for this metadata field, otherwise the value is allowed to be missing. For example all biochemical data objects could be required to have metadata fields defining a “Name” and an “Accession”, but a metadata field defining a “Description” could be optional and therefore not “Required”;

“Single”—if true then the biochemical data object can have only one value for this metadata field, otherwise several are allowed. For example it could be required 2 that a biochemical data object has only one Name, but several Accessions could be permitted;

“Mutable”—if true then the value stored in this metadata field can be altered after the creation of the biochemical data object, otherwise it is fixed. For example, the computing environment could permit a biochemical data object's “Name” metadata to be changed (if the user has sufficient permissions), but its “Accession” metadata may be defined as not mutable.

Typically, the biochemical data objects discussed above may be constructed using an object-orientated class inheritance system. A biochemical data object may then be an instance of a biochemical file type class which is specific to the format of the data in the biochemical data file. This biochemical file type class is itself a sub-class of a more general biochemical data class.

The general biochemical data class defines the common object orientated interface that each of the biochemical data objects must have by specifying the methods that must be present, what type of data the methods return and what arguments the methods should and can take. Each biochemical file type class however defines how these methods are implemented i.e. the exact processing that is needed for any format conversions or any read or other operations that need to be performed on the biological data file.

Similarly the structure of the metadata is typically defined using the object orientated class inheritance system. A general metadata class defines a broad set of attributes that all biochemical data to be handled by the computing environment should have, e.g. type of biochemical data. Then more specific sub-classes expand upon this by including further attributes specific to the particular biochemical data type that the sub-class is related to. Typically each attribute will have a variable associated with it in which to store its value and get( ) and put( ) methods so that the system can read and write to the variable respectively. These sub-classes can then be used to create instances of specific metadata objects in a given biochemical data object or multiple inheritance can be used so that the biochemical file type class of a given biochemical data object inherits from both the general biochemical class and a specific metadata sub-class. Ultimately the values stored in metadata variables are intended to characterize the biochemical data encapsulated in the biochemical data object.

As a consequence of using this object-oriented approach, the computing environment can be extended, for example by end users, by deriving new classes from those initially provided. For example, one could add the capacity for dealing with protein structure data by taking the general biochemical data class and deriving a ProteinStructureFile class from it, including in it additional methods to retrieve the amino acid sequence, say, getAminoAcidSequence( ) and secondary structures such as getSecondaryStructures( ), and so forth.

Hence the system is extensible in that it is possible to define new biochemical and new metadata types. These new metadata types can have their own associated strong typing restrictions as described above.

The object-oriented computing environment 100 illustrated in FIGS. 1 and 2 also provides a plurality of application objects which are provided to create and operate on the biochemical data objects to enable a user to carry out bioinformatics work.

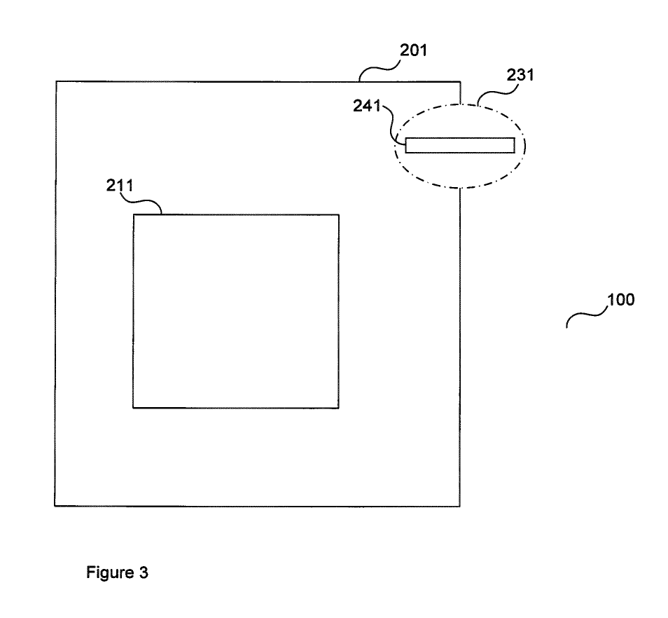

FIG. 3 shows such an application object 201. This application object specifies an operation 211. Typically this operation may be implemented as some form of executable program code which takes as input one or more biochemical data files 111, 112, performs some data processing operations, and outputs one or more biochemical data files. However the operation can be any sort of processing that uses as input or produces as output a biochemical data file. The operation may include the use of scripts such as Python scripts in order to control execution of program code to carry out the operation.

For example, executable code of bioinformatics software systems such as BLAST or BWA could provide a data processing operation by which biochemical data is analysed to produce new biochemical data; a utility such as wget could be used to download a biochemical sequence data file from a network location; and a utility such as sed could be used to replace patterns in a biochemical sequence data file. These would all count as operations that could be encapsulated by the application object.

The purpose of the encapsulation is similar to that when encapsulating the biochemical data files above. Application objects can be used by or in the computing environment 100 to create a new biochemical data object, carry out work on existing biochemical data objects and generate one or more further biochemical data objects, and so forth, while the mechanics of actually executing the underlying operation is abstracted and handled internally by the application object itself.

Some application objects 201, when applied to an existing biochemical data object, will cause a further biochemical data object to be created. This new biochemical data object is created such that it is arranged to encapsulate the biochemical data file expected to be produced by the operation specified by the application object, although as discussed further below this biochemical data file may not be generated or completed until a later time.

Such an application object 201 would also, at time of creation of the object or at a later time, control the execution of the operation on the correct biochemical data in the correct format for the operation. The application object 201 would do this by calling the appropriate method, or indeed methods, of the object orientated interface of the created biochemical data object and passing the data returned by that method or methods to the operation executable. The application object would then handle the taking of the output produced by the operation and, if the output is not already a biochemical data file storing the output in a biochemical data file, and associating the biochemical data file with the new biochemical data object such that the biochemical data file is encapsulated by the new biochemical data object.

One particular way in which this can be achieved is that the application object, as shown in FIG. 3, can have its own object-oriented interface, 231, which provides various methods, 241. One such method can be a run( ) method. This run( ) method would cause the application object to be applied to a biochemical data object. The run( ) method could be called by or from the computing environment 100, passing as arguments the biochemical data object that the application object should be applied to. The method itself will then call the relevant method(s) of the biochemical data object in order to retrieve the input data required by the operation 211 and then execute the operation with this data. The method would also handle the creation of the new biochemical data object as described above, so as to encapsulate the biochemical data file produced by the operation.

As an example, a BLAST program executable could be encapsulated in application object X. As discussed above in connection with FIG. 2, the user wishes to run BLAST on two mouse biochemical sequences stored in biochemical data files P and Q, which in turn are encapsulated in biochemical data objects A and B. The BLAST executable only accepts input data in the FASTQ format, biochemical data file P is in the FASTQ format and biochemical data file Q is in the BAM format. The run( ) method of application object X is called from the computing environment, this method being part of the application object's object orientated interface, passing as argument the biochemical data object A. The run( ) method creates a new biochemical data object C, of the correct type to encapsulate a BLAST XML output biochemical data file. The run( ) method also calls the getFASTA( ) method of biochemical data object A and executes the BLAST application with the FASTA formatted biochemical sequence data returned by getFASTA), this produces a BLAST XML output biochemical data file R. The run( ) method also calls the putSequenceData( ) method of the new biochemical data object C, passing the biochemical data file R, which the putSequenceData( ) method records in the biochemical data object C as the file the biochemical data object now encapsulates. In this process the getFASTA( ) method merely returned the biochemical sequence data as stored in the biochemical data file P. To run BLAST on the other mouse biochemical sequence in object B, the user would have called the run( ) method and passed biochemical data object B. The process would have been exactly the same except that when the getFASTA( ) method of B was called, the getFASTA( ) method would have had to convert the biochemical sequence data stored in the biochemical sequence data file Q into the FASTA format before returning it. At no point in the process would the user or the application object have to consider what format the biochemical sequence data is actually stored in, from both the user and the application object's perspective biochemical data objects A and B work in exactly the same way.

For some application objects, an operation specified by the application object may not require any biochemical data as input. For instance in the example where the operation is the wget utility, the system would just activate the wget application object passing to it the specific URL of a biochemical sequence data file. The wget application object would then handle the executing of the wget utility, in order to obtain the biochemical data file found at the URL, and the creation of the appropriate biochemical data object in which to encapsulate the biochemical sequence data file.

Similarly, some application objects and their encapsulated operation do not produce biochemical sequence data per se as output, for example an application object encapsulating a graphing program. In such a case, the computing environment or user would be able to activate the application object passing to it a biochemical data object, but the application object itself would just execute the graphing program on the biochemical data retrieved with the biochemical data object's object orientated interface and allow the graphing program to present data using the environment's display capabilities. The application object could be arranged to generate a placeholder object recording what graphing operation was performed on what biochemical data object if necessary.

As with biochemical data objects discussed earlier, application objects can be implemented using the class inheritance system in an OOP language. Here, each application object is an instance of a particular application class, which in turn is a sub-class of a generalized application object class.

The methods defined in the general application object class, and the particular application class, allow the application itself to be abstracted.

Again the form of the methods that form the OOP interface of the application objects is usually specified in the generalized application object class, but the actual implementation is left to be defined in the particular application classes which inherit from it. It is in these implementations where it is specified what methods of the common OOP interface of the biochemical data object a given application object will be calling. This is determined by the input data and format of the input data required by the operation that the application object is intended to encapsulate.

As already hinted at above, the process of applying an application object 201 to one or more biochemical data objects, in which a new biochemical data object is created, need not be an atomic one. It can be divided in to two separate processes or stages: a first stage in which a new biochemical data object is created, intended to later fully encapsulate the completed biochemical data file which is to be produced by the operation; and a second stage in which the operation is actually executed and a biochemical data file produced, which is then associated with the new biochemical data object by suitable encapsulation. The two stages may be spaced apart considerably in time, for example with the first stage being part of a planning or organisational process in which a user prepares a sequence of bioinformatics processes, and these processes are later executed when the organisational stage has been completed.

In this way a given biochemical data object can be in one of two states. A first “empty” state corresponds to a biochemical data object that has been created but is essentially a shell, in that the biochemical data file it is to encapsulate is either not present or is not yet complete in some way. A key attribute that the intended biochemical data file lacks at this point is that it is not yet in a state where it can be meaningfully operated on by another application object or operation to produce useful output or further biochemical data.

The biochemical data object then enters a second “initialised” state when the operation specified by the relevant application object has been executed such that the biochemical data object encapsulates a completed biochemical data file. A completed biochemical data file would typically be such that another suitable application object operation can be performed on the biochemical data file such that meaningful output such as further biochemical data can be produced. In this way an “initialised” biochemical data object is distinguished over an “empty” biochemical data object in that an application object can be applied to the former to produce a further biochemical data object which is also ready to be initialised, without any change to the biochemical sequence data file encapsulated in the first biochemical data object.

In particular, the computing environment may be characterised in that transition from the “empty” state towards the “initialised” state is triggered only by a new user instruction or input which is subsequent to the creation of the biochemical data object in the “empty” state, although note that this input may only indirectly relate to this trigger, for example relating to a data flow of which this initialisation forms only a part. Additionally or alternatively, the computing environment may be characterised in that multiple biochemical data objects exist at the same time (and for the same user) in the “empty” state.

The delay between the first stage of creating an empty state object and the second stage of performing the initialization process to convert from the empty state to an initialised state can be short, long or indefinite. The second stage could be performed on demand, triggered, for example, by an attempt to retrieve the as of yet incomplete or non existent biochemical data from the “empty” biochemical data object. It may be advantageous to generate the biochemical data files in this was only when needed because the biochemical data files can be very large.

One way in which the above process may be implemented is illustrated in FIG. 4. An application object 202 encapsulating an operation 211 is applied to an existing biochemical data object 103, for example by a user interacting with a graphical user interface (not shown). The existing biochemical data object 103 may be in an empty state, in which case it does not yet encapsulate a completed biochemical data file 113, or in an initialised state. Application of the application object 202 to the existing biochemical data object 103 leads to the creation of a new biochemical data object 104. To achieve this, the application object 202 may include a run( ) method 242, similar to the run( ) method of the application object discussed above in connection with FIG. 3. The run( ) method 242 could be called by the computing environment, passing as arguments the biochemical data object 103 that the application object 202 is to be applied to. Thus run( ) method 242 would handle the creation of the new biochemical data object 104 which is arranged to later encapsulate the biochemical data file 114 to be produced by the operation 211 of the application object 202. It could also store, in the new biochemical data object 104, links to the one or more biochemical data objects 103 that the application object is being applied to (shown in FIG. 4 stored in the new biochemical data object as dependency link 152), links to the application object 202 itself (illustrated as application link 153) and/or a specific execute( ) method 243 of the application object 202 along with any arguments or parameters that need to be passed to the application object or its method.

The second stage in which the new biochemical data object 104 transitions from the empty state to the initialised state may be implemented by the execute( ) method 243 in the application object 202. The arguments of this method are any required input biochemical data objects 103 and any processing parameters required to execute the operation 211 encapsulated in the application object 202. The action of this execute( ) method 243 is to call relevant method(s) 143 of the object-oriented interface 133 of the input biochemical data object(s) 103 in order to retrieve, from the biochemical data file 113 encapsulated in the existing biochemical data object 103, input data required by the operation 211 and then execute the operation 211 with this data and any processing parameters specified. The method then returns the biochemical data file 114 produced by the operation.

The empty biochemical data object 104 created by the application object 202 may be provided with an initialise( ) method 144 as part of its object-oriented interface 134. When called, this initialise( ) method 144 is arranged to call the execute( ) method 243 of the application object 202 which the new biochemical data object 104 is linked to. The initialise( ) method 144 passes the linked input biochemical data object(s) 103 and any application parameters to the execute( ) method 243 which then returns the new biochemical data file 114 as outlined above. The initialise( ) method 144 than associates this biochemical data file 114 with the new biochemical data object 104 such that the new biochemical data object now encapsulates the biochemical data file in its completed state. At this point, read( ) and other methods 145 of the object-oriented interface 134 of the new biochemical data object 104 will be able to function normally and interrogate the encapsulated biochemical data file 114 for data; the new biochemical data object is now in the initialised state.

In this way, calling the run( ) method 242 of the application object creates a new biochemical data object 104 in the empty state i.e. arranged to encapsulate a biochemical data file that will be produced when the operation of the application object is executed. The empty new biochemical data object includes all of the data and/or links to all of the data required to generate the biochemical data file, but the generation is postponed until the initialise( ) method of the new biochemical sequence data file is called.

It can also be understood that the function of the execute( ) method of the application object can be performed instead by an execute script. This execute script could be one which is specific to the operation specified by the application object. Alternatively the script could be generated specifically for the biochemical data object. The generated script may be generated from some script template specific to the operation specified by the application object. The script and/or the script template could also depend on the specific hardware on which the operation was to be performed. The script could be stored in various different ways and in various different locations, for example, with the application object, the biochemical data object, or generally in the system.

As the various read( ) and other methods 145 of a created biochemical data object may require the biochemical data file 114 to be present to operate correctly, and this data file is not generated until the initialise( ) method 144 of the biochemical data object 104 has been called, the biochemical data object 104 can include an “initialised” flag 150. This flag indicates the current state of the biochemical data object 104. i.e. whether “initialised” or “empty”, depending on whether or not the biochemical data file 114 has actually been completed (generated by the operation 211 and encapsulated). The methods 145 associated with the biochemical data object 104 can then check this flag 150 during their execution if they require access to any data in the biochemical data file. If they find that the biochemical data object 104 is in the empty state they can, if desired, then call the initialise( ) method 144 which will, as described above, then cause the biochemical data file 114 to be generated and thus be available to the method. The initialise( ) method 144 can then set the flag 150 to show that the biochemical data object 104 is indeed initialised.

An “initialised” flag 150 or similar status indicator can also be used to prevent the initialise( ) method 144 from being run on an already initialised biochemical data object, and thus overwriting the biochemical sequence data file present. Similarly, if the existing biochemical data object 103 of FIG. 3 has not yet been initialised, then this may be indicated by an initialised flag 151 of that object, thereby indicating that the data file 113 is not yet completed and thus preventing the above initialization of the new biochemical data file 104 from being attempted as discussed above.

The computing environment 100 may also be provided with functionality to enable a biochemical data object to be returned from the initialised state to the empty state. This could be associated with deletion of the encapsulated biochemical data file, thereby saving storage space. This may be achieved, for example, by the deinitialise( ) method 146 also shown as part of the new biochemical data object in FIG. 4. However, the reverted biochemical data object should then contain or be linked to all of the information, for example in the form of metadata associated with the object, to enable the object to be subsequently reinitialised.

It may be desirable for biochemical data objects, once initialised, to be immutable, in the sense that after a transition from the empty state to the initialised state, the biochemical data file will always be the same in the initialised state, even following one or more reversions back to the empty state, and this immutable property of some or all of the biochemical objects may be enforced by design of the apparatus. Typically, the reversion process to the empty state may only be available to an operator of the apparatus, and not to end users. This immutability will be effective for operations which are deterministic, and this property ensures robustness of the apparatus. To this end, the apparatus may be arranged such that some but not all of the operators found in application objects are permitted to be the subject of a biochemical data object transition back to an empty state. Examples of operations where this may not be appropriate are operations which import biochemical data from a remote source using a URL, and bioinformatics operations which are not deterministic to a sufficiently high level of accuracy.

The computing environment may also use various flags associated with metadata 121,122 of each biochemical data object to control when and the extent to which certain aspects of a biochemical object, and in particular associated metadata items, are required for an action to take place, and/or can be changed, for example by an end user. These are particularly useful in controlling aspects of initialisation and immutability of the biochemical data objects. Some example flags are set out in the following table:

| Flag | Explanation |
|---|---|
| REQUIRED_FOR_INITIALIZATION | initialise( ) fails if this flag is set for a metadata |
| | item with no value |
| | File Reference metadata, which point to other |
| | data objects, should be used for building data |
| | flows if marked with his flag |
| | this flag can only be set for data objects with |
| | NotStarted or Failed initialization status |
| FROZEN_AFTER_INITIALIZATION | a field with this flag can not be changed after |
| | initialization |
| | this flag can only be set for data objects with |
| | NotStarted or Failed initialization status |
| SET_BY_INITIALIZATION | should be set from initialise( ) method only |
| | all fields with this flag should be ignored when |
| | creating file by template |
| USED_AS_DATA_SOURCE | this is a “light version” of |
| | REQUIRED_FOR_INITIALIZATION for data |
| | objects with NotApplicable initialization status, |
| | e.g. for genome browser pages |
| | values marked with this flag should be used for |
| | building data flows |
| | this flag can only be set for files with |
| | NotApplicable initialization status |
| | this flag is only applicable to File Reference |
| | metadata |
| FILE | marks that the field should be File Reference |
| | metadata |

In considering this table, note that data flows are discussed in more detail below. The File Reference type of metadata, which points to other biochemical data objects, can be used for various purposes such as the dependency links 152 discussed above, and for associating biochemical data objects with semantic and other links.

An alternative to the initialised flag, as described above, can be implemented using these flags associated with the metadata. For instance if all of the metadata items that are flagged as SET_BY INITIALIZATION are indeed set then the biochemical data object can be assumed to be initialised. A biochemical data object can have an isInitilised( ) method which can determine if all of the metadata items that are flagged as SET_BY INITIALIZATION are indeed set and then return information on whether a biochemical data object is initialised or not. The method can also be arranged to return more descriptive information, for example as described in the following table:

| Returned Information | Explanation |
|---|---|
| NotApplicable | this is not an initialisable biochemical |
| | data object |
| NotStarted | initialisation not yet started |
| InProgress | biochemical data object is being |
| | initialised |
| Complete | successfully initialised |
| Failed | biochemical data object failed to io |
| | initialise |
| ConfigurationError | an error in the configuration (e.g. |
| | invalid parameters) |

As discussed above and illustrated in FIG. 4, a biochemical data object can depend upon other biochemical data objects in the computing environment. More specifically the calculation of data for a biochemical data file encapsulated by one biochemical data object may require the prior results of the calculation of data for a biochemical data file encapsulated in one or more other biochemical data objects upon which it depends. We refer to this dependency of one calculation step on another as a data flow, which of course can involve multiple dependent steps of a chain of calculations involving many such dependencies.

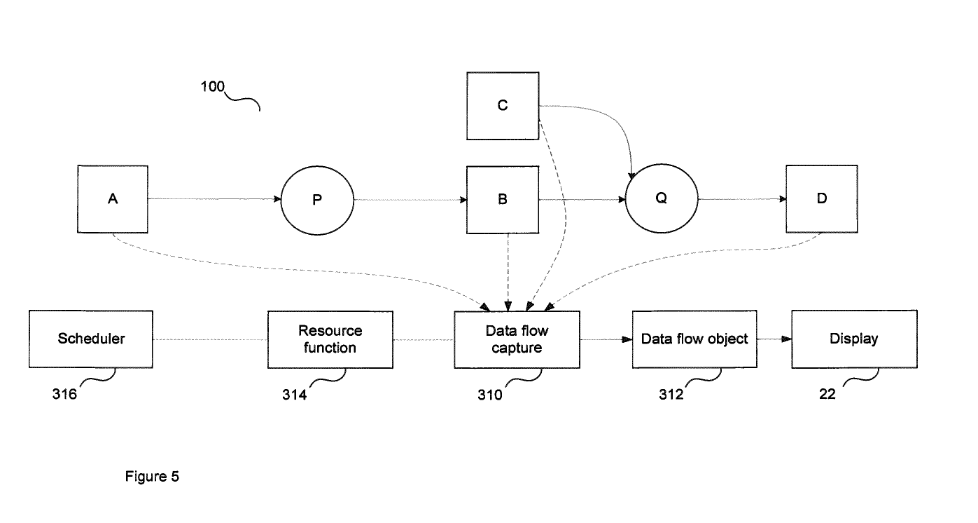

FIG. 5 illustrates such a data flow within the computing environment 100. In this data flow a biochemical data object A is acted upon by an application object P to form a biochemical data object B. Application object Q then acts on both biochemical data objects B and C to form biochemical data object D.

The computing environment 100 can track these dependencies using links between biochemical data objects such as the dependency link 152 shown in FIG. 4 or some functionally equivalent data which indicates upon which other biochemical data objects a particular biochemical data object immediately depends. It can then be seen that a whole data flow of empty biochemical data objects can be triggered such that all of the objects are initialised in the correct sequence, by following the data flow. This action could be triggered, for example, by a request to initialise the final object D automatically triggering initialisation of each empty object back along the dependency chain of the data flow. This automatic initialisation could be built into the functionality of the initialise( ) method 144 illustrated in FIG. 3. In turn, whether or not a first object can be initialised may be detected for example on the status of an initialised flag 150,151 of a second object on which it depends, and this detection could be carried out by a read( ) method of the second object which is called as part of the initialisation, or more directly detected by the initialise( ) method itself.

Take, for example, the data flow shown in FIG. 5, and assume that only biochemical data objects A and C have been initialised. When the initialise( ) method of biochemical data object D is called, this method attempts to execute the operation in application object Q on biochemical data objects B and C. This involves calling read( ) methods of both B and C. A read method of C will execute immediately as C is already initialised. The read method of B will however first trigger the initialise( ) method of B to be executed. This initialise( ) method will attempt to execute the operation in application object P on the biochemical data object A. Again this will involve a read( ) method of biochemical data object A being called. As A is already initialised this read( ) method will execute immediately and the operation of application object P will be able to execute successfully. Hence B will now be initialised. As the initialization operation of B has now completed successfully its read( ) method of be will now return the requested data, allowing the operation of application object Q to execute successfully, with the data from both C and B, thus successfully initializing biochemical data object D. In this way all of the dependencies are handled implicitly and the system does not need to calculate the dependencies explicitly beforehand.

However the data flows implicitly tracked in the computing environment through data such as metadata associated with each biochemical data object can also be explicitly generated, for example using a data flow capture function 310 as shown in FIG. 5. The data flow capture function may achieve this in various ways, but one such way is for the data flow capture function 310 to traverse back along the dependency tree of any given biochemical data object, generating as it goes an explicit representation of the data flow, which can be stored in a data flow object 312. This explicit data flow can then be analysed further and used by other functions in the computing environment, for example to check if the data flow is invalid, for example by including circular dependencies in which a first object depends upon a second object, which in turn depends upon the first object, albeit through multiple levels of dependency. The data flow capture function could be implemented as an application object which is applied for example to a single or multiple selected biochemical data objects, and then derives the explicit data flow dependencies for those objects, optionally also including dependencies of further objects dependent on the selected object(s).

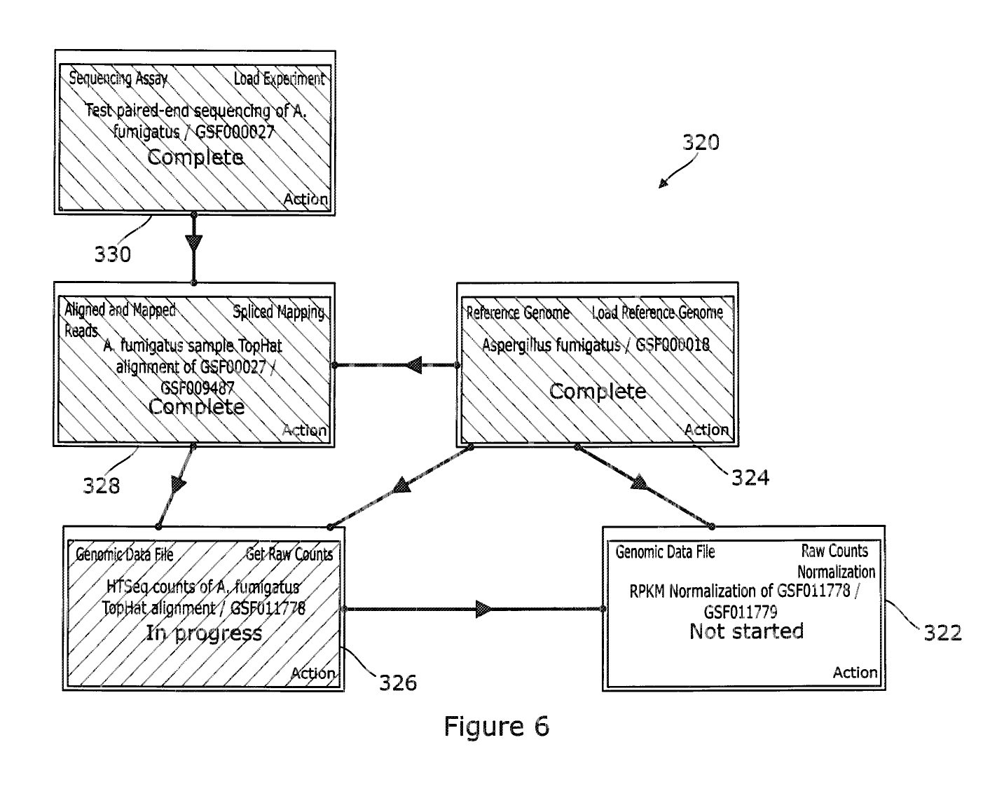

An explicit representation of a data flow generated by the data flow capture function could be visually presented to a user of the system on a display, allowing the user to better see how a particular piece of analysis has progressed and all of the different biochemical data objects involved. This presentation could be implemented as functionality of a data flow capture application object. FIG. 6 shows a practical example of a visual presentation 320 of a data flow, presented to a user through a graphical user interface of the computing environment. In this example, we see how the initialisation of a biochemical data object 322 encapsulating RPKM-normalised gene expression values depends on a reference genome 324 and on an HTSeq Counts file 326, which in turn uses the same reference genome 324 and an aligned and mapped reads file 328, produced from a sequencing assay 330 and also using the same reference genome 324 as input. From the labels in the display boxes corresponding to each biochemical data object, it can be seen that the genome object 324, the sequencing assay object 330, and the reads file object 328 are all marked as “complete” and have therefore been initialised. The HTSeq Counts file object 326 is marked as “in progress” because the calculation of its biochemical data is currently in progress, as this box is in a state of transition from empty to initialised. The RPKM-normalised gene expression values object 322 is marked as “not started”, and is therefore in an empty state, waiting for completion of the biochemical data file of the HTSeq Counts file object 326 to be completed before its own initialisation takes place.

If a dependency problem such as circular dependency is detected then the computing environment 100 could automatically prevent certain operations and actions, for example preventing any initialisation of a biochemical data object forming part of the invalid data flow. Such functionality, optionally including the actual detection of a dependency problem, could be encapsulated for example within the initialise( ) method 144 discussed above, and whether or not a data flow is invalid could be reflected in a graphical user interface presented to a user of the computing environment.

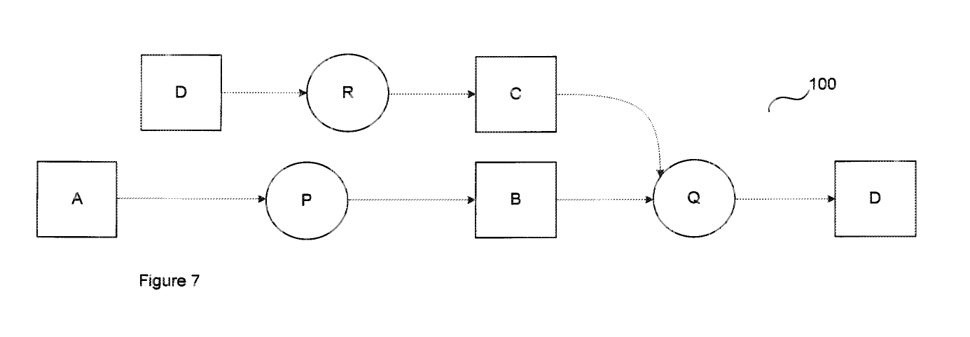

An example of a circular dependency can be seen in FIG. 7 in which biochemical data object C is now formed by applying application object R to biochemical data object D. Hence in order for D to be initialised C must be initialised first. But the initialization of C requires D to already be initialised and hence the data flow is not valid. The system can catch such circular dependencies and prevent the data flow from being executed, preventing the situation where the initialise methods of biochemical data objects B and C recursively call each other in an endless loop.

The initialization steps in some data flows may be very processor intensive. The computing environment 100 may therefore provide functionality, such as resource function 314 shown in FIG. 5, to analyse a data flow or data flow object 312 to determine which biochemical data objects have yet to be initialised, and what computing resources (processor time, memory etc.) such initializations would require. Such functionality allows the system to schedule the execution of the processor intensive initialization steps of one or more data flows in order to best utilize the available computing resources, for example by scheduler 316. For instance a very processor intensive data flow may be scheduled for execution at a time when the overall load on the available computing resources is low, or initialization steps which have high memory requirements may be executed in tandem with steps that have low memory requirements. This scheduling is arranged by the resource function 314 and scheduler 316 system to remain within the constraints of the relevant data flow and its included dependencies.

The use of such biochemical data object data flows can make it particularly advantageous to impose constraints on how and when biochemical data objects can be modified. For example, once a biochemical data object has been initialised the computing environment may then, according to a system policy, make certain data in the biochemical data object and/or the associated metadata immutable. This would ensure that once a first biochemical data object has been initialised, and its completed biochemical data file has therefore become available for other biochemical data objects to depend on, this first biochemical data cannot be changed. This ensures the integrity and consistency over time of any further biochemical data object whose own biochemical data is to be or has been derived from the been derived, at least in part, from the data of the first object.

We have described above how inspection and auditing of biochemical data object dependencies and therefore provenance is provided by the computing environment. Every biochemical data object contains in its metadata the complete information required for its re-computation, including all parameters for the operation of the relevant application object, and identifiers of all input biochemical object files.

The concept of data flow can also be used to create new biochemical data files and data flows, for example either reusing a complete data flow or just part of an existing data flow, by replication or re-use of the data flow and making changes to the details of the data flow such as input parameters before initialising the objects of the new data flow.

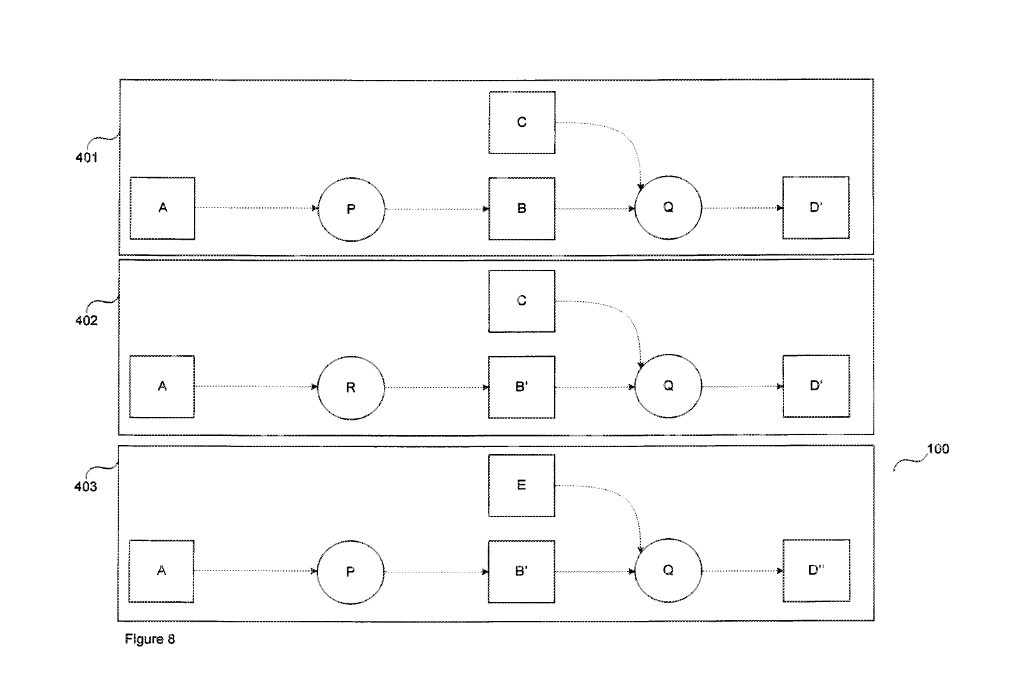

FIG. 8 illustrates re-use of an existing data flow. In the data flow 401 of the top panel of the figure, a user has replicated the role of data object D in FIG. 4 to give a new biochemical data object D′. This could be formed as an largely identical or templated copy of D, for subsequent modification by the user, including optionally changing the identity of the application object Q and/or its parameters, it could be formed as a minimally defined biochemical data object for details to be added by the user, or in other ways. However, because D′ is dependent according to its role in data flow 401 upon objects B and C, the rest of the data flow of FIG. 4 upon which object D depends is implicitly duplicated in data flow 401. Object D′ has the same links to its immediate ancestors as D, so that tracing back through the data flow 401 associated with D′ gives the same results as that associated with D.

In the middle panel of FIG. 8, a user elects to replicate the role of object B in data flow 401 as a new biochemical data object B′ upon which other objects depend. Again, B′ may be initially formed as a direct or templated copy of B for subsequent modification by the user, or in other ways. The effect of forming B′ is that the data flow 401 is branched to the new object B′. The object A upon which B′ depends is implicitly the same as that for B in data flow 401, so does not change. However, to re-use the existing data flow, the data flow role of object D′ must be replicated, forming new object D″, which could be formed as a templated replica of D′, or in other ways. The new objects B′ and D″ in new data flow 402 can then be edited by the user to modify the new data flow 402 for example by changing parameters for the application objects P and Q, or by changing one application object for another as shown by the change from P to R. The new modified data flow 402 can then be executed in the manner described above, by calling the initialise( ) methods of the new objects B′ and D′, taking into account the order of their dependencies, and any initialisation which may still be required of other objects such as A and C.

The lower panel of FIG. 8 shows a further development of the data flows 401 and 402, in which a user elects to re-use the work flow with the role of biochemical data object C replicated in new object E. The objects A and B′ are unaffected by the change because of their dependencies, but the object D″ depends upon both B′ and C, so its role in the data flow is also automatically replicated, as new object D′″. Changes to objects E and D′″, including changes to the application object Q and the parameters used to calculate the date of D′″ may now be made before the new parts of the data flow are initialised.

The above functionality can be implemented using a user interface in which a user can elect to re-use the whole or part of an existing data flow. A role in the data flow of a particular biochemical data object can be replicated for example by providing a graphical user interface component enabling a user to select an existing biochemical data object using a object-chooser component for use in the replicated role, and/or the user interface including the option of replicating the existing data object in that role for subsequent editing. A graphical user interface could also or instead allow a user to duplicate or choose a new application object for replicating the role of that application object in the data flow, thereby re-using the data flow in a similar way to as described above.

The isInitialised( ) method described above can also be extended in conjunction with dataflows. In addition to checking metadata items of the method's own biochemical data object the isInitialised( ) method can check the metadata items of the other biochemical objects in the dataflow upon which the method's own biochemical object depends. The method can further be arranged to return additional descriptive information, for example as described in the following table:

| Returned Information | Explanation |
|---|---|
| Pending | biochemical data object is waiting for |
| | dependencies to be initialised before |
| | beginning initialisation. |
| ConfigurationErrorInSources | An error in one of the source |
| | biochemical data objects |
| DependencyCycleError | the dataflow leading to the biochemical |
| | object has a circular dependency |
| SourceNotAccessibleError | one of the dependencies is |
| | inaccessible |

Repeated re-use of data flows, copying of biochemical data objects for modification, and similar activities which occur in bioinformatics work where many different combinations and options for data analysis take place, can be difficult for the user to organise and keep track of. The present computing environment therefore provides an automatic or semi-automatic way of updating metadata of biochemical data objects, such as names and text descriptions of those objects, thereby improving the organisation of a users work.

To this end, a metadata field of a second biochemical data object may comprise at least one descendent metadata field which comprises metadata from at least one parent metadata field from a first biochemical data object upon which the second biochemical object is directly or indirectly dependent for calculation of its biochemical data. Similarly, a descendent metadata field may comprise metadata from at least one parent metadata field set by an application object upon which the biochemical data object is directly or indirectly dependent for calculation of its biochemical data. A descendent metadata field may also comprise metadata from another metadata field of the same biochemical data object. Similarly, a descendent metadata field may comprise metadata from at least one parent metadata field from the same biochemical data object as the descendent metadata field. In any of these cases, the metadata passed from the parent field to the descendent field may include part or all of the parent field.

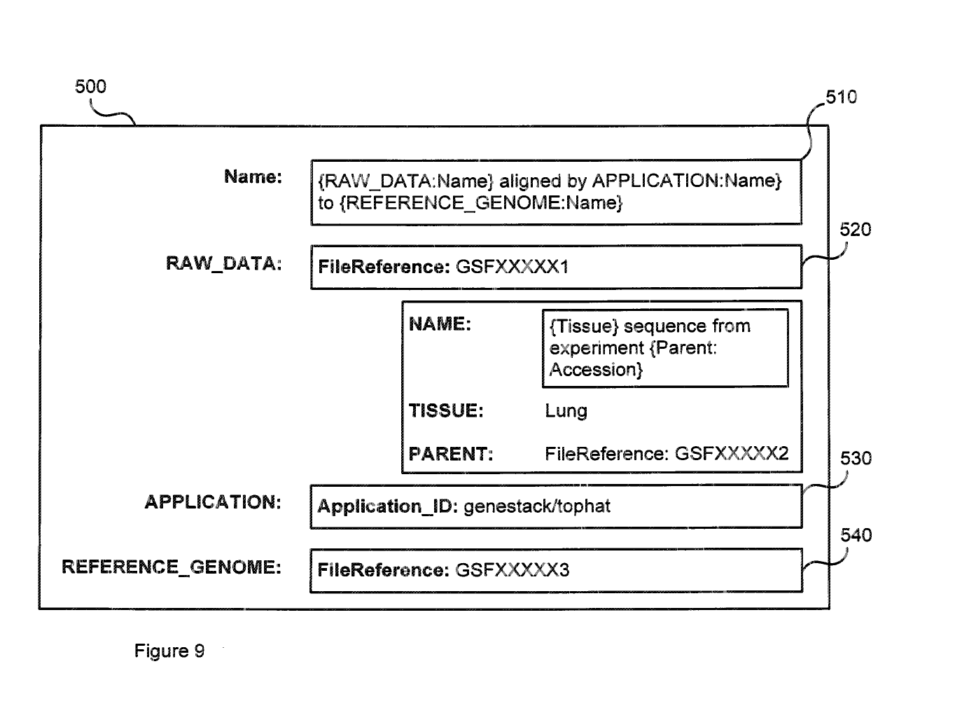

Referring for example to FIG. 9 there is shown a representative set of metadata 500 of a biochemical data object. It can be seen that some of the metadata fields of the object are descendent metadata fields because they contain metadata sourced from other metadata fields, either from the same biochemical data object, another biochemical data object, or from a metadata field set by an application object. This metadata sourcing can be by reference or direct copying, for example, but in the example of FIG. 9 it can be seen that references to other objects are used.

In particular, the name field 510 of metadata 500 is a text string which includes a text string obtained by reference to a RAW_DATA Name field which can be obtained through the RAW_DATA:FileReference metadata link 520 to the RAW_DATA biochemical data object. Similarly, the name field 510 of metadata 500 also includes a text string obtained by reference to an APPLICATION Name field which can be obtained through the APPLICATION:Application_ID metadata link 530 to the relevant application object. Similarly, the name field 510 of metadata 500 also includes a text string obtained by reference to a REFERENCE_GENOME Name field which can be obtained through the REFERENCE_GENOME:FileReference metadata link 540 from the reference genome biochemical data object.

Clearly, using these techniques, another metadata field to which a descendent metadata field refers can itself refer to another metadata field, thereby being recursive back to an originating metadata field, and in this way, descendent metadata fields can be automatically updated when a data flow or aspects of a data flow are changed, for example following copying part of a data flow for re-use. The process described above whereby a metadata field is at least partly based on another metadata field in the same or another object may be described as templating, in the sense that a descendent metadata field is formed of a template into which data from other metadata fields is explicitly or implicitly inferred or copied. In this way, when a data flow is re-used to replicate and modify a previous bioinformatics analysis, or a biochemical data object is used as a template to create a new object, fields such as the name of any new biochemical data objects are immediately updated with attributes of the new data flow and changed as it is modified for the new analysis.

As discussed above, the object-oriented computing environment provides a graphical user interface which enables a user to create and process biochemical data objects 101-104 using application objects 201,202 to carry out bioinformatics work. In this graphical user interface (GUI), biochemical data objects are presented to the user using an object browser in a manner similar to data files in the graphical user interface of a conventional computer operating system, so that in the following figures the object browser may also be seen referred to as a “file browser”. The object browser and associated graphical output is presented on a conventional computer display, and the user can interact with the GUI using conventional peripherals such as a keyboard, computer mouse, touch screen functionality on the display and so forth.

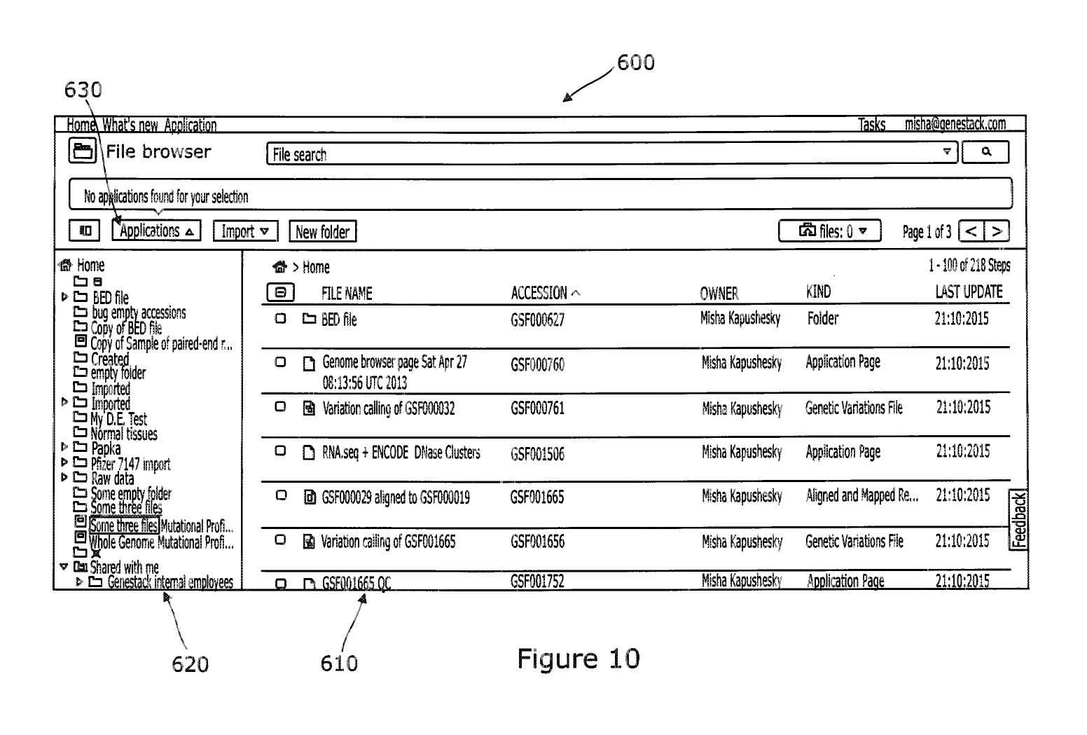

Referring to FIG. 10 there is illustrated a display window of a GUI object browser 600. The object browser 600 can display the biochemical data objects available to the user in a similar visual manner to files and folders in a traditional GUI file manager on a traditional operating system. Here the biochemical data objects 610 listed under the heading “file name” is displayed as if it were a file in a file browser. As a result the biochemical data objects 610 can be organized into folders 620, including providing options for the user to create their own folders so as to help the user find the biochemical data objects 610 they require more easily.

As with a traditional file browser, biochemical data object 610 can appear in more than one folder through the use of links, and this linking system can interact with a user access control system outlined elsewhere in this document in which users are allocated to user groups. For example, when a new user group is created, all its members gain access to a new group folder. Sharing biochemical data objects amongst the group members can then be effected by creating links to the relevant objects in the group folder and setting up appropriate permissions for the object-group pairs. Each user that is a member of the group will then automatically see the shared biochemical data objects listed whenever they look at the group folder.

The object browser 600 enables the user to select one or more biochemical data objects 610, for example by using a check box, and to apply an application object to the one or more selected objects. In FIG. 10 an “applications” button 630 can be used to list application objects which may be used, but at present no biochemical data objects have been selected, so no relevant application objects are available. Generally, the object browser only permits applications to be applied to selected biochemical data objects where the nature of the selected data and application objects make this appropriate. This functionality can be implemented for example by only displaying to a user for selection those application objects which are appropriate, or by showing appropriate and inappropriate application objects using a different graphical style.

In order to implement this functionality, each application object may have an accepts( ) method which determines whether it is appropriate for use on particular biochemical data objects. This implementation involves using an accepts( ) method in the general class for all application objects which is called when the computing environment is to decide whether a particular application object can be launched for a given selection of one or more biochemical data objects. The implementations of this accepts( ) method are in each particular application class. If the accepts( ) in method returns a result “true”, then the application object is shown to the user amongst choices of applications available to run on the selected data objects.

The accepts( ) method has access to the metadata associated with each of the selected biochemical data objects. Thus an application object uses the metadata associated with a biochemical data object when determining whether the biochemical data object selected matches the functionality of the application object. This allows the object browser and computing environment overall to function intelligently, suggesting only meaningful applications to users on selection of particular data objects.

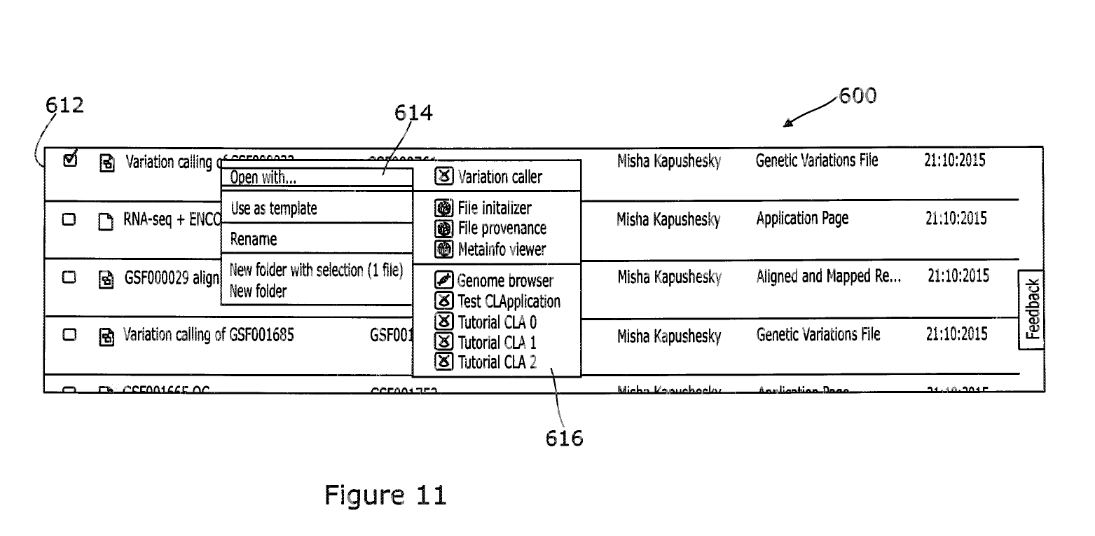

FIG. 11 shows a part of the display of the object browser 600 of FIG. 10 in which a particular biochemical data object 612 has been selected, triggering a context menu 614 which has an “Open with . . . ” option. When a GUI pointer is hovered over the “Open with . . . ” option a list 616 of available application objects is displayed. This list 616 is composed by the computing environment by calling the accepts( ) method of each application objects with the one or more selected biochemical data objects as parameters. For each application object that returns “true” when the accepts( ) method is called, the name of that application object is added to the displayed list.

As shown in FIG. 11, the list of application objects displayed to the user may be separated into three parts, shown as top, middle and bottom sections of the list 616 in FIG. 11:
first part, listing zero or up to one application object for each selected biochemical data object, which is the application object that created the selected biochemical data file originally. This part of the list can be empty, because not all biochemical data objects are created within the computing environment, or created by an application object that can view them (biochemical data objects may also be imported into computing environment).
second part, zero, one or more application objects: application objects that provide viewing functionality for this kind of data object
third part, zero, one or more application objects: application objects that can use the selected biochemical data object(s) as a source to create a new data object.

The user can then simply select the desired application object to start the process of applying that application object to the selected biochemical data object.

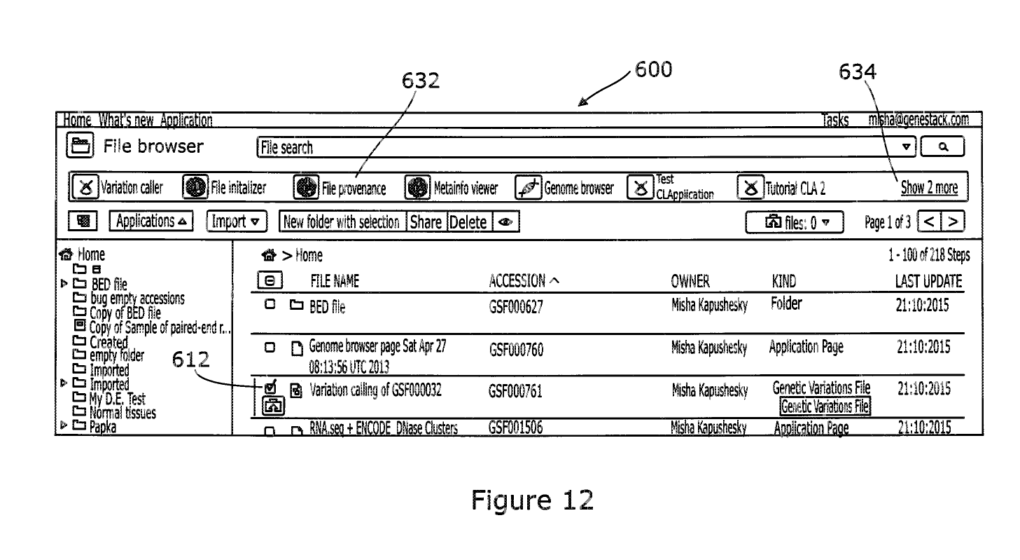

Alternatively, as shown in FIG. 12, a separate application pane 632 can be used to display the application objects that are able to be used with a selected biochemical data object. The underlying list is populated in the same way as before but this time it is generated as soon as the user selects a given biochemical data object. This selection also causes the application pane 632 to refresh automatically with the contents of the list. If there are too many application objects to be shown in the application pane 632 then the pane may display a button or clickable text 634 which would show further application objects not currently visible.

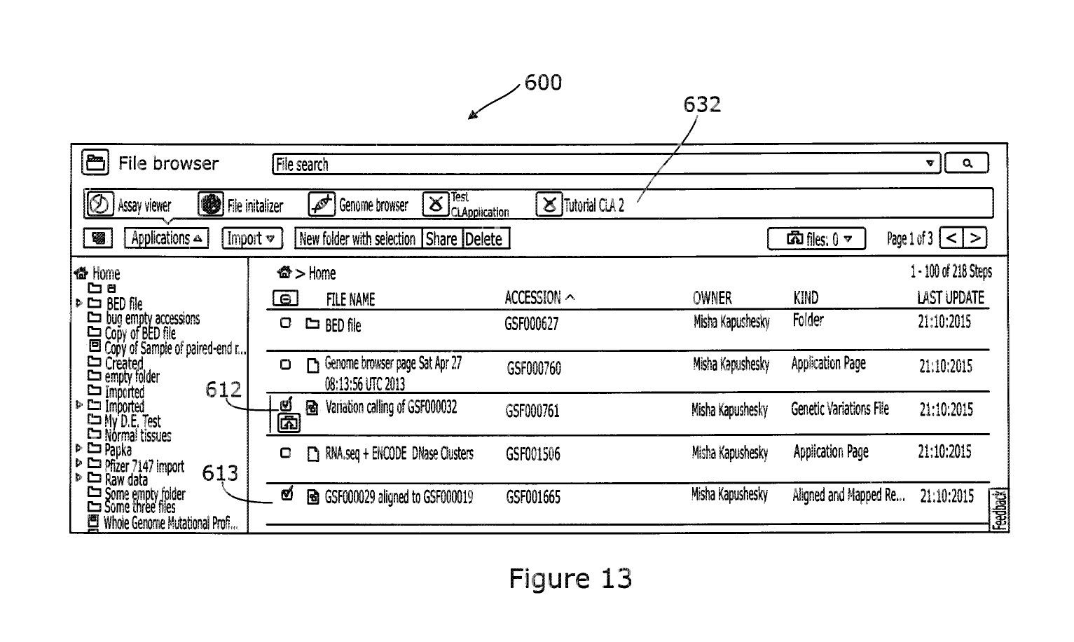

If multiple biochemical data objects have been selected at the same time in the object browser, then the same principles are applied. In this case the accepts( ) method each application object can be passed multiple biochemical data objects return true or false based on whether the given application object can be applied to all of the biochemical data objects selected together, i.e. the operation specified by the application object is capable of taking the biochemical sequence data in the selected biochemical data objects as multiple inputs. FIG. 13 shows this implemented in the objet browser 600. Here two biochemical data objects “Variation calling of GSF000032” 612 and “GSF000029 aligned to GSF000019” 613 have been selected. As a consequence, the computing environment has called the accepts( ) method of every application object, or every application object which might be of interest according to some pre-filtering scheme, passing to the method the two selected biochemical data objects. Each application object where the accepts( ) method has returned “true” has then been included in a list, and that list of application objects has been displayed in the application pane 632.

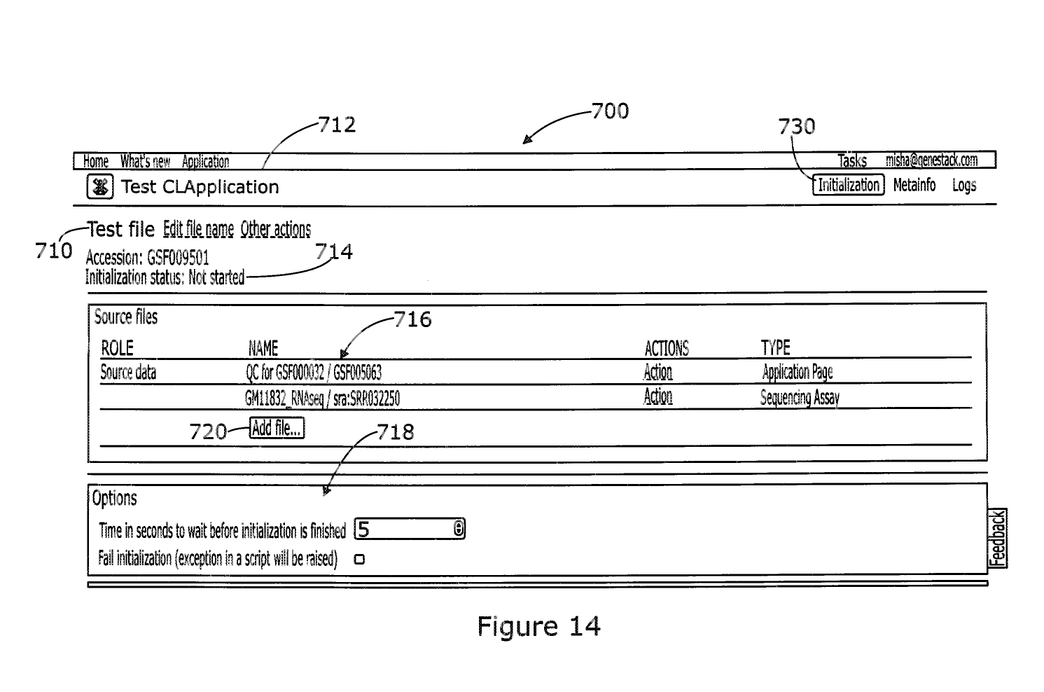

FIG. 14 provides an example of a biochemical data object display window 700 of the object browser or GUI. This object display window 700 may be shown when a user selects a particular biochemical data object in a particular way, for example by also selecting the application object with which the data object was formed, or when a biochemical data object is newly formed by applying an application object to one or more input (selected) biochemical data objects which is used when a particular application object has been selected for applying to or running on one or more biochemical data objects.

The name of the given biochemical data object 710 is displayed (in this case the name “Test file”), along with the name of the application object 712 that was used to create the biochemical data object, and which has or will be used to initialise it from the empty status to the initialised status. Also displayed are the initialization status 714, in this case “Not started” indicating that the data objet remains in the “empty” state; direct ancestor biochemical data objects 716 which form the input to the application object from which the present biochemical data object is the output; and any parameters used by the application object when initializing the given biochemical data object.

Note that the biochemical data to be encapsulated by the biochemical data object represented by the object display window 700 of FIG. 14 has not yet been computed: its initialization status is indicated as “Not started”. Also note that this biochemical data object has as its direct ancestors two other biochemical data objects and more can be added using the “Add file . . . ” button 720. Finally, note that the parameters with which this biochemical data object is to be computed are still editable, because initialisation has not yet started.

For simplicity of explanation, the application object forming the biochemical data object which is the subject of FIG. 14 a test application which simply takes several biochemical data objects of any kind as input and produces a dummy biochemical data object, whose initialization does no computation, but simply waits for a specified number of seconds. However, essentially the same or a similar object data display window can be used for a variety of different application objects providing, for example, various bioinformatics calculations, viewing tools and so forth.

Initialisation of the biochemical data object displayed in the object display window 700 of FIG. 14 can be started, for example, by operating the “Initialisation” control 730, or using a similar context menu displayed if the “Other Actions” element is activated. The initialisation status 714 will then be updated to “pending” while the relevant processing is scheduled, then to “in progress” while the various required calculations are carried out, and to “complete”. If the initialisation process failed then the parameters of the object become editable again.

For application objects creating new bioinformatics data in the biochemical data file of the object, once the data file has been created as part of the initialisation process, and this is therefore complete, the biochemical data object becomes immutable as discussed above. A system operator may be enabled to return the object to the “empty” status, thereby releasing data storage by deleting the calculated biochemical data, but the immutable nature of the object prevents any edits which would cause the recalculated data from a further initialisation to be different to that of the first initialisation.

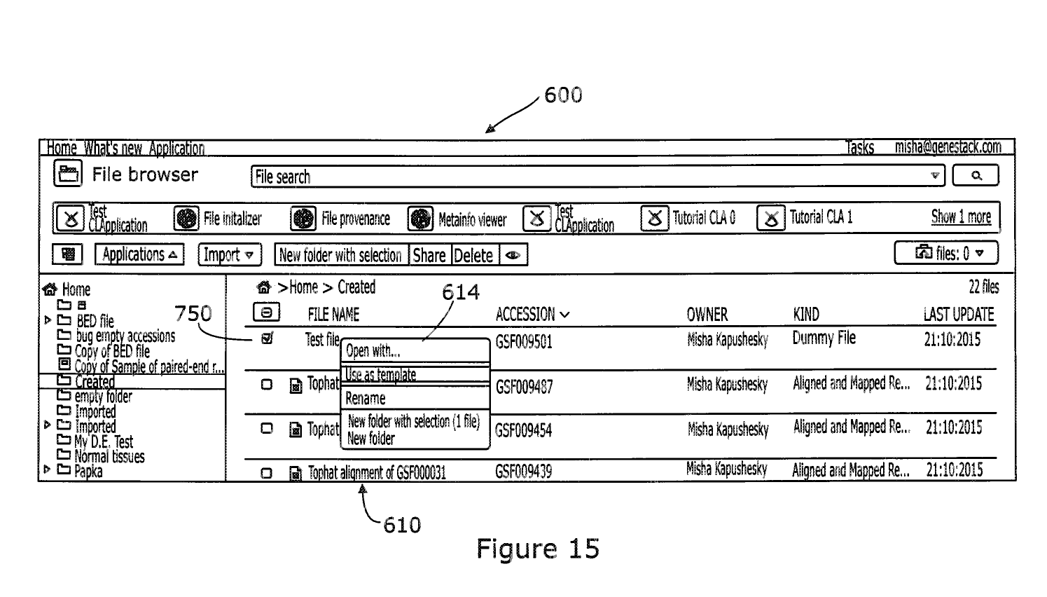

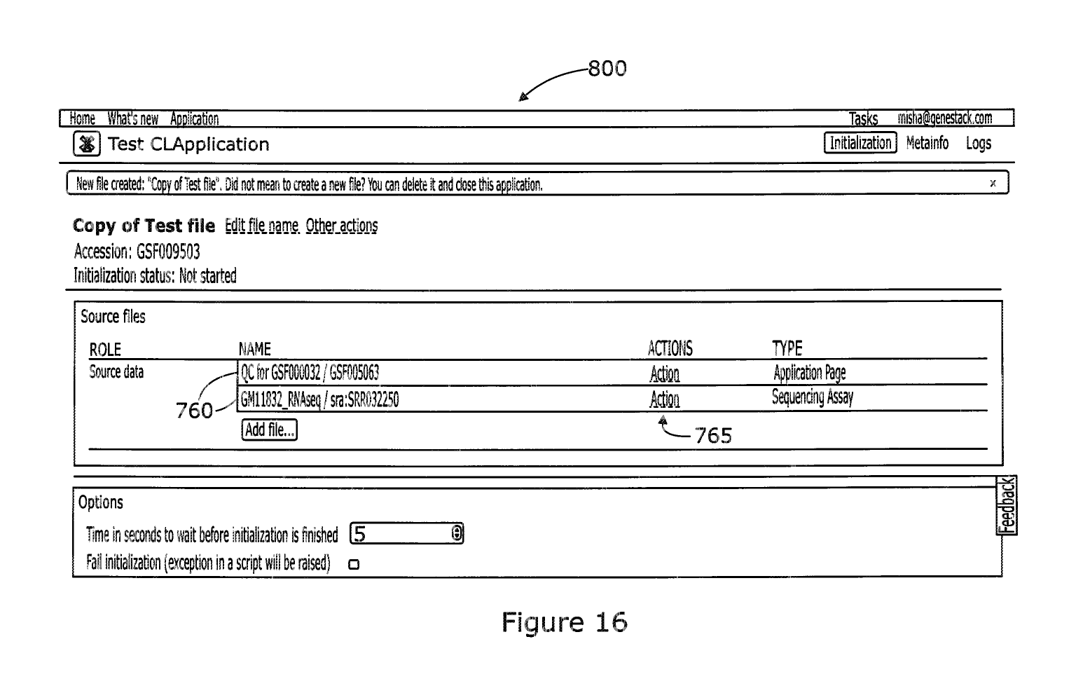

FIG. 15 shows how a user can use the object browser 600 to replicate an existing biochemical data object for modification and use in a further bioinformatics data flow. This is a simple one-step means to replicate a biochemical data object in the system. Having selected a biochemical data object 750, the action “use as template” is selected from the context menu 614. FIG. 16 shows an object display window 800 resulting from this action, showing a newly created copy of the selected biochemical data object 750. A default initial name has been given to this object as “Copy of Test file”.

The replication of the selected biochemical data object 750 has already happened at this point and the new biochemical data object “Copy of Test file” has been created. It can be seen that the initialisation status of the newly replicated biochemical data is “Not started”. The metadata representing the two input biochemical data objects 760 (sources) for the original biochemical data object 750 were copied also, and in this case others can be added, or the existing sources changed using the Action item 765. Various parameters are editable, and user can modify them and then start initialization as discussed above.

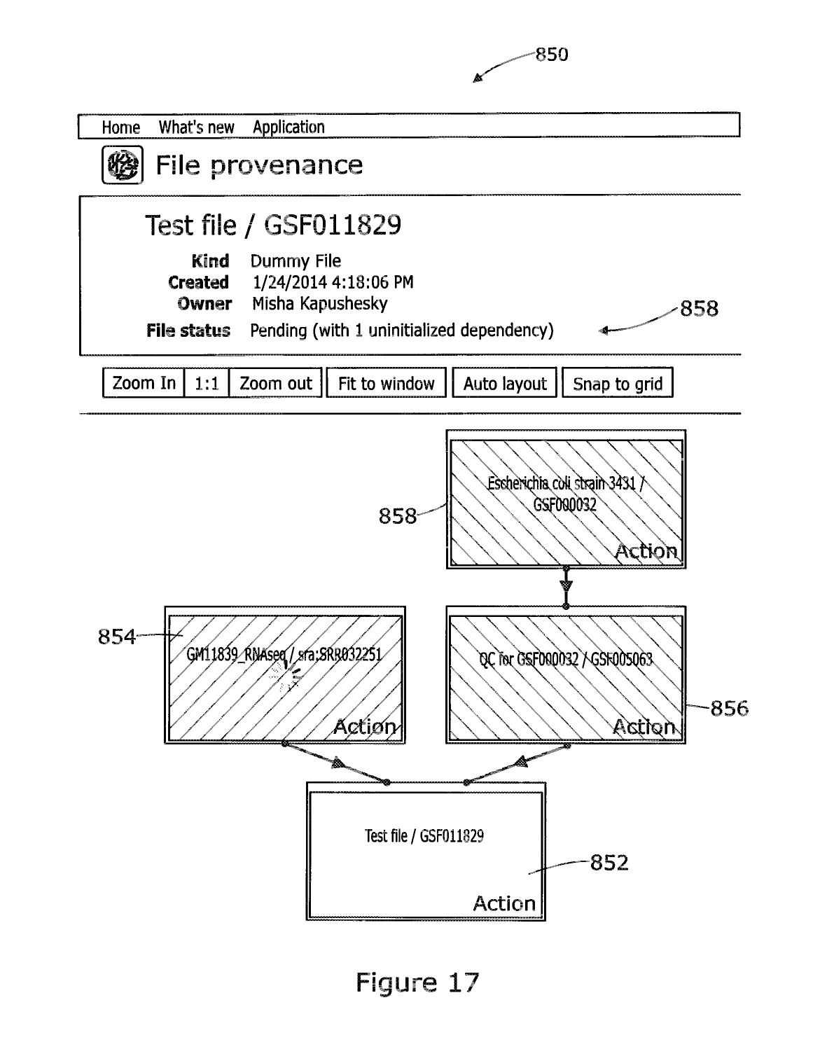

As already discussed in connection with FIG. 5, the computing environment provides functionality to determine the dependencies in a data flow associated with a given biochemical data object, for example using a data flow capture function 310 as illustrated in that figure. The object browser 600 or otherwise the GUI therefore enables a user to examine the provenance of a given biochemical data object, or data flow, including for example the state of all dependencies that need to be initialised in order to initialise the given biochemical data object. This functionality may be provided by a data object provenance application which can be run on a selected biochemical data object to provide a data object provenance display window 850 as shown in FIG. 17.

In the data object provenance display window 850, the selected biochemical data object 852 is at the bottom of the window, and is shown to have two direct ancestors 854, 856, one of which on the left 856 has a further ancestor 858. As shown in the “File status” element 858 one of the direct dependencies, indicated in a lighter colour as dependency 854, has not been initialised, and hence the originally selected biochemical data object itself cannot be initialised, and is shown as “Pending”.

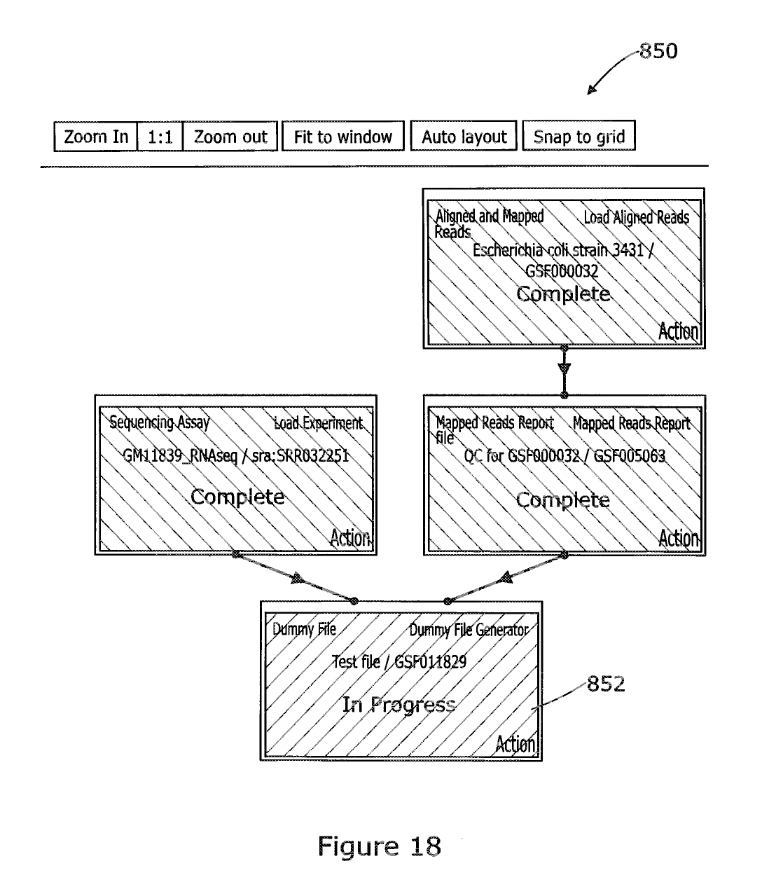

FIG. 18 shows the data object provenance window 850 in a later state when all the dependencies 854, 856,858 of the selected object 852 have been initialised. The window 858 now indicates all dependencies to have been computed so as to be in the initialised state (“Complete”), so that the initialisation of the originally selected biochemical data object 852 can progress (“In progress”). When initialisation of the object 852 is complete, this will be reflected in the file status element 858 shown in FIG. 17.

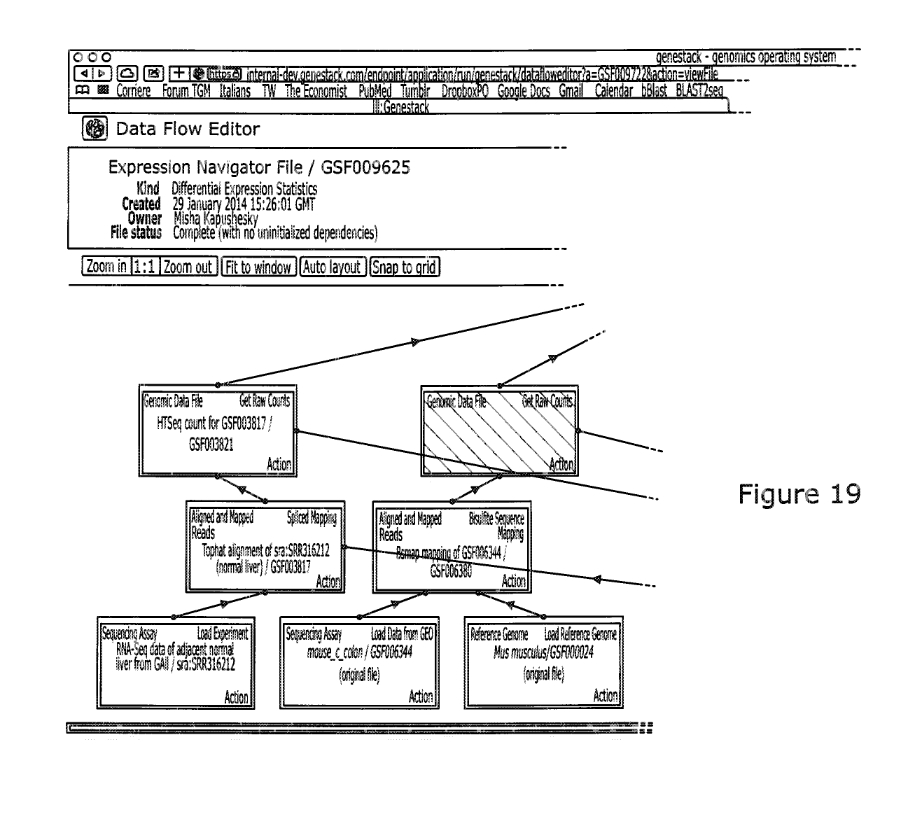

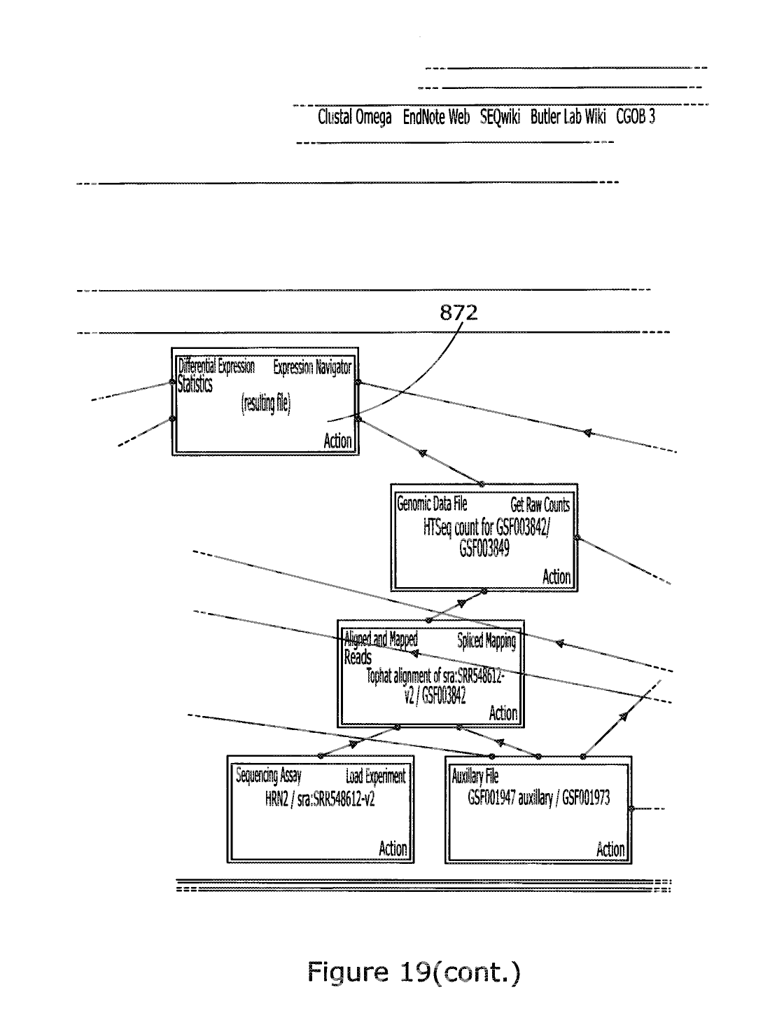

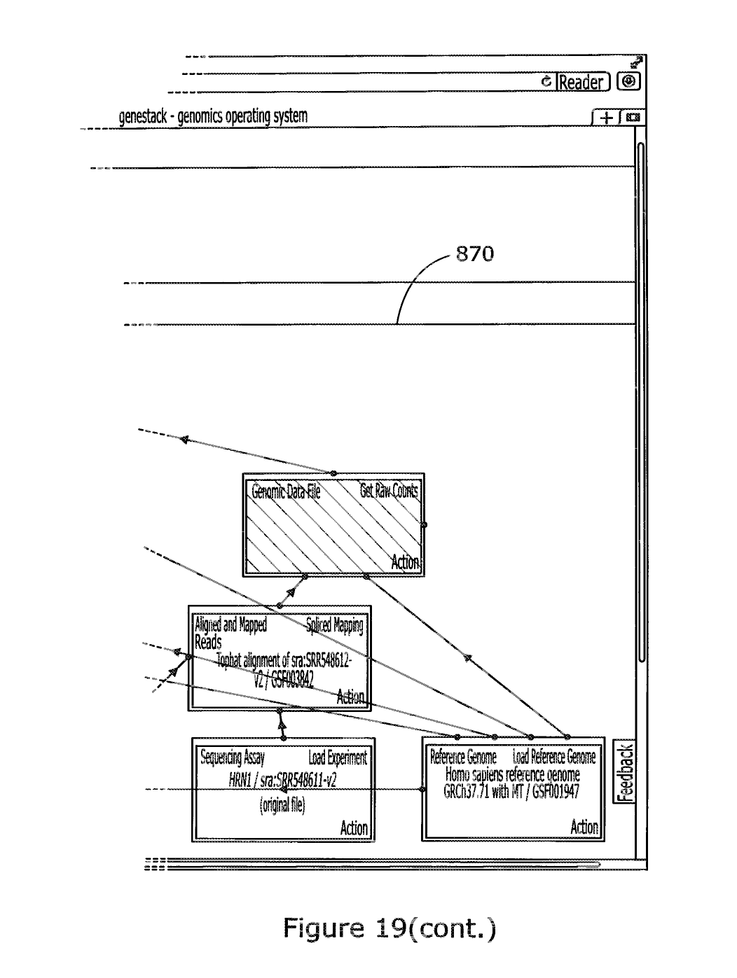

The object browser and/or other elements of the graphical user interface also provide facilities for a user to replicate or replay an existing data flow consisting of dependencies between multiple biochemical data objects as discussed above, for example using data flow replay tool 870 as illustrated in FIG. 19. The display of the GUI of the data flow replay tool 870 shows a final biochemical data object 872, and multiple other biochemical data objects on which the final object 872 depends either directly or indirectly, with arrows showing the dependencies as a dependency graph. This graph replicates an existing data flow, providing options for fulfilling each data flow role in the new data flow with existing or new biochemical data objects.

Describing each biochemical data object in the display as a node, each node in the graph a node can be in one of the following states:

Original: a name of a biochemical data object for the node is suggested, and would typically correspond to the biochemical data object which has the same data flow role in the original data flow. All nodes may default to this initially.

Empty: there is currently no biochemical data object for the node.

Filled: there is a user selected biochemical data object for the node.

For any given node, the data flow replay tool 870 enables the user to alter its state, either by clearing the currently allocated biochemical data object from the node, replacing it with another biochemical data object or reverting back to the suggested biochemical data object. The user also has the option of opening or running a biochemical data object currently at a node with a different application, and or different parameters.

If a user chooses a “Select another . . . ” option on a node, he is presented with a file chooser that will only permit selection of biochemical data objects which have the same file type as or are otherwise compatible with the existing state of the node. After selecting another biochemical data object in the file chooser, the node will be updated. Consistent with the concept of immutability and persistence of existing data flows, the data flow resulting in the previous biochemical data object is then removed from the graph and any data flow on which the newly selected biochemical data object depends is added.

If the user chooses a “Select original” action on a node, the original biochemical data object for that node is reinstated, along with any data flow on which that object depends.

If the user chooses a “Clear” action on a node, then the node is cleared of any biochemical data object, and name, accession and status of the node are not displayed in the node. Data flow roles dependent on the selected node are then retained but also become empty.

The data flow replay tool 870 also provides a “Create files” control. It is only enabled when there are no nodes in the “original” state discussed above, and when all “leaf” nodes (nodes with no further nodes dependent upon them) have been populated. When this control is activated, all empty nodes get filled with new empty biochemical data objects templated from their ancestors as specified in the graph.

When initializing a biochemical data object, an isolated, sandboxed environment may be created by the computing environment on a dedicated compute node. The computing environment then ensures that the initialization method (typically based on a script in the Python programming language) is executed within this sandbox, meaning that the method has limited permissions, and no visibility or access to any other processes or methods being run on the node and no visibility or access to any biochemical data objects other than those accessible by the computing environment user under whose control the process is running. As far as the method is concerned it is the only running process on the compute node. The method is only able to interact with the wider computing environment through a limited set of APIs providing it with GET and PUT methods to retrieve from and deposit data with the wider environment with appropriate automated format conversions, and a limited ability to call methods of other biochemical data objects, provided the user that owns the biochemical data object that is being initialised has the appropriate permissions to make these calls. The described computing environment may be used just by a single user, but could instead be used by large collaborative groupings or even whole institutions of users. In order to enable many users, who each may belong to different or multiple groups, to use the computing environment, the environment may also enforce user access and control. This may be done by means of a variation on more conventional role-based models, using defined users, groups and organizations, together with a fixed permissions set.

The computing environment can define multiple “organizations” which each describe large entities such as corporations, universities etc. Each “user” in the environment then belongs to exactly one organization. Each user can belong to any number of “groups” on the system. Groups can be intra- and inter-organizational. In an organization there are two “roles”: administrators and regular users. In a group there are three roles: administrators, sharing users and non-sharing users.

The extent to which users, or groups of users can interact with objects is determined by the permissions a user or group has been granted. Permissions can be attached to objects (biochemical data objects, application objects, etc.) but also to individual methods within an object. For instance a biochemical data object may have a general read/write permission allowing any user or group with that permission to call the read/write methods of the object may also require that a user wishing to call the initialise method of the object hold a separate permission for just that method.

When permissions are granted to a group, all users who are members of that group are treated as if they were granted those permissions.

Each object has an associated user that is its owner. This is usually the user that created the object although this can be changed by administrators. Sharing users of a group can share objects which they own with their group. Non-sharing users only get access to objects shared with the group. This allows data confidentiality to be enforced by the administrators of groups or organizations, such that confidential information from one group cannot be shared without authorization with another group by a user who is a member of both groups.

Membership of groups is to a large extent user directed. Any user can create a user group. User A in group G may invite user B to join the group, provided both user A and user B are members of the same organization and provided user A is an administrator of group G. If user B accepts then user B is a member of group G. However if user A was a member of a different organization to user B then the organization administrators of both user A's organization and user B's organization would have to approve the invite before user B was able to become a member of group G. Typically, once such organizational approval is given, any group administrator for that group can add any other user from any organization that is a member of that group.

Because the described computing environment specifies each operation inside an application object instantiated from a given particular application class, the system makes it particularly straightforward to introduce new operations from third-party developers. All the developers need to do is to create a new particular application class, inheriting from the general application class. This new class just needs to have the required methods to be implemented and the system can use the new operation in conjunction with all of the existing functionality. it is also possible to extend the system by authoring new biochemical data object classes and new metadata type classes, i.e. broadening the number of data types the system can work with, formats it can work with, and metadata it can store.

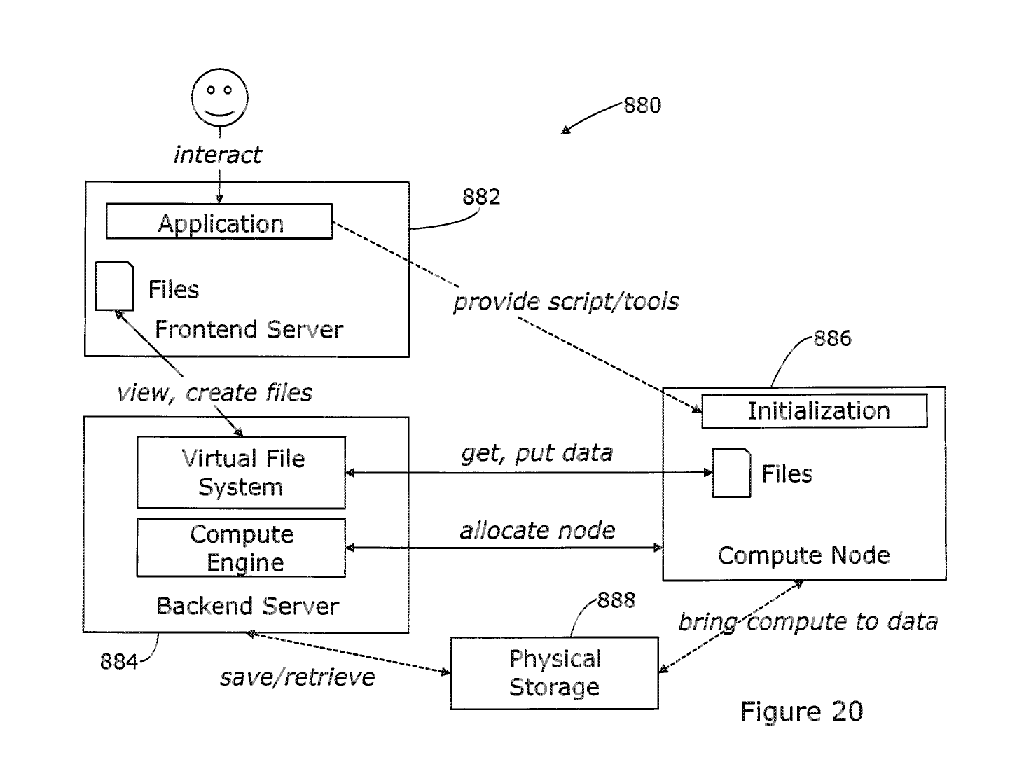

As FIG. 20 shows, the described computing environment can be implemented in a heterogeneous hardware environment, such as a distributed cluster 880. Note that in this figure the biochemical data objects are referred to as “files”. One particular implementation uses a frontend server 882, a backend server 884, and one or more compute nodes 886. The user interacts with the system through the frontend server 882 and it is here that the user can view biochemical data objects, create new biochemical data objects and select application objects to be applied to various biochemical data objects. The objects themselves are managed and stored by the backend server 884. The backend server provides all of the system processing, such as the construction of data flow objects, scheduling of object initialization etc. It also has access to a physical storage layer 888 where the system data and the biochemical data objects are actually stored. The backend server also, in managing object initialization manages one or more of the compute nodes 886, assigning them to the initialization tasks associated with the biochemical data objects.

It is on the compute nodes 886 that the actual operations, encapsulated in the application objects, are actually executed in order to initialise biochemical data objects. These compute nodes also have access to the physical storage layer 888 (which can be provided by a distributed file system such as LustreFS) and so can write the biochemical data objects directly.

Although aspects of the computing environment discussed in detail above have been described in connection with the analysis and storage of bioinformatics data, such as biochemical sequence data, it will be appreciated that this is just one area to which the invention can be applied. Indeed, some aspects of biochemical data that are particularly relevant to the invention include:

biochemical data frequently comprises data that takes up a large amount of storage space on a computer system;

biochemical data can often be reused multiple times across different data analysis paths (or data flows);

biochemical data is often represented in different, incompatible, data formats;

repeatability of previously executed data flows is important i.e. it is important that the data produced by a series of analysis steps should remain the same if that analysis is repeated in future.

Therefore the various aspects of the invention can provide significant benefit in various other fields of application, especially when one or more of the above aspects applies.

One such exemplary field is financial risk modelling, where:

The underlying financial data can be large; the historical performance of a large number of financial instruments using a short time-step could comprise a very large number of data points.

The data may need to be re-used multiple times; multiple different models could be applied to the same data to obtain a range of predictions about the future performance of the financial instruments.

The repeatability of previous modelling of the future performance of financial instruments is important; regulatory burdens may be such that the modelling analysis performed previously may need to be audited by other agencies at a later date.

When the invention is applied to financial risk modelling, the biochemical data objects would become financial data objects. These financial data objects would encapsulate underlying financial data stored in financial data files. These data may be the historical performance of a particular financial instrument, or the predicated performance of a financial instrument or set of financial instruments calculated using a financial model, or covariance data related to given portfolios of financial instruments. The operations encapsulated by the application objects would typically apply various models and financial tools such as the Black-Scholes model, Gaussian cupolas or Value at Risk models to the financial data encapsulated in the financial objects.

It is clear how the other aspects of the invention could be applied in other analogous ways, for example, to high volume image or video processing, where there is a large number of image processing/rendering steps that may need to be replicated on a large number of images or frames.

Other variations and modifications to the described embodiments will also be apparent to the person skilled in the art, for example the dataflows described could be implemented without the “lazy initialisation” aspects whereby biochemical data objects are first formed in and “empty” state and only later transitioned into an “initialised state” encapsulating the completed biochemical data file. Working versions of the invention could be implemented on a single device such as a single personal computer, or on a range of more complex systems having multiple processors, multiple nodes, network connections, distributed storage and the like.

1. Apparatus for providing an object-oriented computing environment for analysing biochemical data,
the apparatus being arranged to construct a plurality of biochemical data objects, each biochemical data object being arranged to encapsulate a biochemical data file within which biochemical data is recorded,
the apparatus being arranged to construct each biochemical data object such that it comprises a plurality of metadata fields, one or more of the plurality of metadata fields specifying provenance of the biochemical data of the biochemical data object.

2. The apparatus of claim 1 arranged to construct one or more of the biochemical data objects such that:
the biochemical data of each such object may be recorded according to any of a plurality of different predefined formats suitable for that biochemical data; and
each such biochemical data object provides an interface to one or more methods for reading the biochemical data from the biochemical data file, the interface being arranged to return the read biochemical data in a form which is invariant to which of the predefined formats the biochemical data is recorded in the biochemical data file.

3. The apparatus of claim 2 wherein the interface to the one or more methods for reading the biochemical data is invariant between the plurality of biochemical data objects and between different ones of the predefined formats.

4. The apparatus of claim 1 arranged to construct one or more of the biochemical objects to encapsulate a biochemical data file in which the biochemical data is biochemical sequence data.

5. The apparatus of claim 4 wherein the predefined formats of biochemical sequence data include one or more of the following formats: FASTQ, SFF, SRA, CRAM, SAM, BAM.

6. The apparatus of claim 1 wherein the metadata fields specifying provenance of the biochemical data identify one or more of the following to which the biochemical data relates: an organism species; a strain of an organism species; an age of an organism; a tissue type.

7. The apparatus of claim 1 wherein the metadata fields specifying provenance of the biochemical data identify one or more of the following used in calculation of the biochemical data:
another biochemical object and its biochemical data, a reference genome, an assay, a group of assays, an experiment, a group of experiments, a set of genomic variations, a set of gene differential expression statistics.

8. The apparatus of claim 1 further comprising a plurality of application objects, each application object specifying an operation adapted to at least one of: accept biochemical data from a biochemical data object for processing by the operation; and deliver biochemical data resulting from the operation to a biochemical data object.

9. The apparatus of claim 8 wherein the operation specified by the at least one application object is arranged to receive biochemical data from one or more biochemical data objects, and to output visualisation data derived from said received biochemical data.

10. The apparatus of claim 8 wherein at least one of the application objects is arranged to create a new biochemical data object.

11. The apparatus of claim 10 wherein the operation specified by the at least one application object is arranged to retrieve biochemical data for a biochemical data file from a remote source for encapsulation in the new biochemical object.

12. The apparatus of claim 10 wherein the operation specified by the at least one application object is arranged to receive biochemical data from one or more existing biochemical data objects, and to output biochemical data for a biochemical data file for encapsulation in the new biochemical data object.

13. The apparatus of claim 12 wherein the operation is a bioinformatics operation.

14. The apparatus of claim 10 wherein the new biochemical data object comprises an execute script arranged to implement the operation.

15. The apparatus of claim 10 wherein the at least one application object is arranged to create the new biochemical data object in an empty state in which the biochemical data file is not yet complete, the new biochemical data object being arranged to subsequently transition, using the operation specified by the application object, from the empty state to an initialised state in which the biochemical data file is complete.

16. The apparatus of claim 15 wherein the subsequent transition is triggered by a user interaction with the computing environment which takes place after creation of the new biochemical data object in the empty state.

17. The apparatus of claim 15 wherein the apparatus is arranged to create, under instruction from a user, a plurality of biochemical data objects in the empty state before any of the plurality are transitioned to an initialised state.

18. The apparatus of claim 15 wherein the subsequent transition is triggered by a method of the new biochemical data object attempting to read from the biochemical data file.

19. The apparatus of claim 15 wherein the transition from the empty state to the initialised state is carried out by calling an initialise method in the object-oriented interface of the new biochemical data object.

20. The apparatus of claim 15 wherein the new biochemical data object includes one or more metadata flags indicating whether the biochemical data object is in the empty state or the initialised state.

21. The apparatus of claim 15 wherein the new biochemical data object is adapted to subsequently transition from the initialised state back to the empty state, including discarding the biochemical data in the encapsulated biochemical data file, whereby the new biochemical data object is enabled to subsequently transition back to the initialised state.

22. The apparatus of claim 21 arranged such that, after a transition from the empty state to the initialised state, the biochemical data object is immutable such that any subsequent transition to the initialised state yields the same biochemical data in the encapsulated biochemical data file.

23. The apparatus of claim 15 arranged such that the transition from the empty to the initialised state of a first of the biochemical data objects requires the biochemical data from a second of the biochemical data objects, and is therefore dependent upon the second biochemical data object being in the initialised state, thereby forming a data flow dependency between the first and second biochemical data objects, a graph of such data flow dependencies between a plurality of biochemical data objects forming a data flow in which each biochemical data object has a data flow role.

24. The apparatus of claim 23 further comprising a data flow capture function arranged to follow a chain of data flow dependencies to determine the graph of data flow dependencies.

25. The apparatus of claim 23 wherein the first biochemical data object further comprises an object-oriented method arranged to return the initialisation state of said first biochemical data object in dependence on one or more metadata flags of one or more of the plurality of biochemical data objects forming the data flow.

26. The apparatus of claim 23 arranged such that a user initiated transition from the empty to the initialised state of a selected biochemical data object automatically causes transition to the initialised state of at least some of the biochemical data objects in the empty state upon which the selected biochemical data object directly or indirectly depends according to the graph.

27. The apparatus of claim 23 arranged to determine if the graph is invalid, in the sense that not all of those ones of a plurality of biochemical data objects forming a graph according to their dependencies which are in the empty state can be transitioned to the initialised state.

28. The apparatus of claim 23 further comprising a resource function arranged to schedule transition, of those of a plurality of biochemical data objects forming a graph which are in the empty state, to the initialised state.

29. The apparatus of claim 28 wherein the resource function is arranged to schedule the transitions according to at least one of: available memory resources for completing the encapsulated biochemical data files; and available processor time for completing the encapsulated biochemical data files.

30. The apparatus of claim 23 further comprising a user interface enabling a user to reproduce at least a part of an existing data flow for subsequent use in a modified form.

31. The apparatus of claim 30 wherein the user interface is arranged to enable the user to replicate the data flow roles of one or more biochemical data objects forming part of an existing data flow to form corresponding new biochemical data objects in the replicated roles, to thereby re-use at least a part of the data flow in a modified form.

32. The apparatus of claim 31 wherein the user interface enables the user to choose a copy of an existing biochemical data object to use in the replicated data flow role of the selected biochemical data object.

33. The apparatus of claim 31 wherein the user interface enables the user to choose a copy of the selected biochemical data object to use in the replicated data flow role of the selected biochemical data object.

34. The apparatus of claim 32 wherein the user interface enables the user to edit properties of the chosen biochemical object for use in the replicated data flow role.

35. The apparatus of claim 31 comprising automatically replicating the data flow roles of one or more biochemical data objects dependent upon the one or more data flow roles selected for replication by the user.

36. The apparatus of claim 1 wherein the plurality of metadata fields of a second biochemical data object comprise at least one descendent metadata field which comprises metadata from at least one parent metadata field from a first biochemical data object upon which the second biochemical object is directly or indirectly dependent for calculation of its biochemical data.

37. The apparatus of claim 36 wherein the plurality of metadata fields of a biochemical data object comprise at least one descendent metadata field which comprises metadata from at least one parent metadata field from the same biochemical data object.

38. The apparatus of claim 36 wherein the descendent metadata field comprises a reference to the parent metadata field, and the metadata is comprised in the descendent metadata field by means of the reference.

39. The apparatus of claim 38 wherein the descendent metadata field is comprised in the descendent metadata field by means of recursive references through one or more parent metadata fields each of which is in turn a descendent metadata field of another parent metadata field.

40. The apparatus of claim 36 wherein the descendent metadata field is a text field descriptive of the biochemical data object to a user.

41. The apparatus of claim 39 wherein the descendent metadata field is a name field of the biochemical data object.

42. The apparatus of claim 36 arranged such that a descendent metadata field is automatically updated if a directly or recursively related parent metadata field is modified.

43. The apparatus of claim 8 further comprising a graphical user interface enabling a user to select one or more of a plurality of biochemical data objects graphically represented to the user, and to apply an application object graphically represented to the user to the selected biochemical data object(s).

44. The apparatus of claim 43 wherein the graphical user interface only permits the user to apply the selected biochemical data object(s) to an application object which has provided an acknowledgement that it can accept the selected biochemical data object(s) as input.

45. The apparatus of claim 44 wherein the graphical user interface provides a display grouping of one or more application objects comprising only those application objects which have each provided an acknowledgement that they can accept the currently selected biochemical data object(s) as input.

46. The apparatus of claim 43 wherein the graphical user interface provides one or more controls enabling a user to instruct the apparatus to transition a selected biochemical data object from an “empty” in which the biochemical data file is not yet complete, using the operation specified by the application object, an initialised state in which the biochemical data file is complete.

47. The apparatus of claim 43 wherein the graphical user interface provides a display of a graph of data flow dependencies between a plurality of biochemical data objects forming a data flow in which each biochemical data flow object has a data flow role, the data flow dependencies arising from the transition from the empty to the initialised state of a first of the biochemical data objects requiring the biochemical data from a second of the biochemical data objects.

48. The apparatus of claim 47 wherein the graphical user interface enables a user to copy the data flow roles of one or more of the biochemical data objects forming an existing data flow, and to edit the copied data flow roles to thereby re-use at least a part of the existing data flow for a new bioinformatics data flow.

50. A method of operating an object-oriented environment comprising:
constructing a plurality of biochemical data objects, each biochemical data object being arranged to encapsulate a biochemical data file within which biochemical data is recorded.

51. The method of claim 50 wherein each biochemical data object is constructed such that it comprises a plurality of metadata fields, one or more of the plurality of metadata fields being arranged to specify provenance of the biochemical data to be recorded in the biochemical data file.

52. The method of claim 50 wherein the biochemical data is biochemical sequence data.

53. The method of claim 50 further comprising:
providing an application object specifying an operation;
running the application object on at least a first one of said biochemical data objects encapsulating a first biochemical data file, to create a second one of said biochemical data objects in an empty state in which it is arranged to encapsulate a second biochemical data file;
subsequently initialising the second biochemical data object from the empty state to an initialised state, comprising the operation acting on the at least a first one of said biochemical data files to create the second biochemical data file, and the second biochemical data file being encapsulated by the second biochemical data object.

54. The method of claim 53 wherein the operation comprises a bioinformatics calculation.

55. The method of claim 54 wherein the transition from the empty state to the initialised state of the second biochemical data object requires the biochemical data from the at least a first one of the biochemical data objects, and is therefore dependent upon the at least a first one of the biochemical data objects being in the initialised state, thereby forming a data flow dependency between the second and the at least a first one of the biochemical data objects, a graph of such data flow dependencies between a plurality of biochemical data objects forming a data flow in which each biochemical data object has a data flow role.

56. The method of claim 55 further comprising reproducing at least a part of an existing said data flow by creating one or more new biochemical data objects having the same data flow roles in the new data flow as one or more corresponding biochemical data objects in the existing data flow

57. The method of claim 50 wherein each biochemical data object is constructed such that it comprises a plurality of metadata fields, one or more of the plurality of metadata fields being arranged to specify provenance of the biochemical data to be recorded in the biochemical data file, wherein the plurality of metadata fields of a particular biochemical data object comprise at least one descendent metadata field which comprises metadata from at least one parent metadata field, which is from a first biochemical data object upon which the second biochemical object is directly or indirectly dependent for calculation of its biochemical data.

58. One or more computer readable media comprising computer program code arranged to carry out the following operations when executed on a suitable computer system:
constructing a plurality of biochemical data objects, each biochemical data object being arranged to encapsulate a biochemical data file within which biochemical data is recorded, such that each biochemical data object comprises a plurality of metadata fields, one or more of the plurality of metadata fields specifying provenance of the biochemical data of the biochemical data object.
